(19) United States
(12) Patent Application Publication
(10) Pub. No.: US 2024/0255681 A1
(43) Pub. Date: Aug. 1, 2024

(54) OPTICAL FILTER

(71) Applicant: AGC Inc., Tokyo (JP)

(72) Inventors: Yuichiro ORITA, Fukushima (JP); Kazuhiko SHIONO, Fukushima (JP); Takuro SHIMADA, Fukushima (JP)

(73) Assignee: AGC Inc., Tokyo (JP)

(21) Appl. No.: 18/444,829

(22) Filed: Feb. 19, 2024

Related U.S. Application Data
(63) Continuation of application No. PCT/JP2022/030832, filed on Aug. 12, 2022.

(30) Foreign Application Priority Data
Aug. 20, 2021 (JP) 2021-135204

(51) Int. Cl. G02B 5/20

(52) U.S. Cl. CPC G02B 5/208

(57) ABSTRACT

An optical filter includes: a substrate; and a dielectric multilayer film laid on or above at least one major surface of the substrate, in which the substrate includes a resin film including a resin, a UV pigment 1 having a maximum absorption wavelength in 360 nm to 390 nm in the resin, and an IR pigment having a maximum absorption wavelength in 680 nm to 800 nm in the resin, and the optical filter satisfies all of spectral characteristics (i-1) to (i-8).

### CROSS-REFERENCE TO RELATED APPLICATIONS

This is a bypass continuation of International Patent Application No. PCT/JP2022/030832, filed on Aug. 12, 2022, which claims priority to Japanese Patent Application No. 2021-135204, filed on Aug. 20, 2021. The contents of these applications are hereby incorporated by reference in their entireties.

### TECHNICAL FIELD

The present invention relates to an optical filter that transmits light in a visible wavelength region and shields light in an ultraviolet wavelength region and light in a near-infrared wavelength region.

### BACKGROUND ART

In an imaging device including a solid state image sensor, in order to satisfactorily reproduce a color tone and obtain a clear image, an optical filter that transmits light in a visible region (hereinafter, also referred to as “visible light”) and shields light in an ultraviolet wavelength region (hereinafter, also referred to as “ultraviolet light”) and light in a near-infrared wavelength region (hereinafter, also referred to as “near-infrared light”) is used.

As the optical filter, for example, a reflection type filter is known in which interference of light is used by a dielectric multilayer film in which dielectric thin films having different refractive indices are alternately laid on or above one surface or both surfaces of a transparent substrate, and light desired to be shielded is reflected. In such an optical filter, since an optical film thickness of the dielectric multilayer film is changed according to an incident angle of light, for example, in a case in which light is incident at a high incident angle, a light leak may occur in which near-ultraviolet light that has high reflectance is transmitted. Since an image sensor has sensitivity also in a near-ultraviolet light region, in a case in which a light shielding property of the near-ultraviolet light is not sufficient, an image quality degradation due to unnecessary light called flare or ghost may occur in an acquired visible light image. Thus, there is a need for a near-infrared light and ultraviolet light cut filter in which spectral sensitivity of the solid state image sensor may not be affected by the incident angle.

Here, Patent Literatures 1 and 2 describe optical filters in which an absorption layer containing a near-ultraviolet light absorbing pigment and a near-infrared light absorbing pigment in a transparent resin and a dielectric multilayer film are combined, and which has both a near-ultraviolet light cutting ability and a near-infrared light cutting ability.
Patent Literature 1: JP6020746B
Patent Literature 2: JP6773161B

### SUMMARY OF INVENTION

However, the optical filters described in Patent Literatures 1 and 2 are designed to shield near-ultraviolet light at incident angles of up to 30 degrees, but there is room for improvement in shielding property at even higher incident angles.

An object of the present invention is to provide an optical filter that has a high transparency of visible light and a high shielding property of near-infrared light and ultraviolet light, and in which flare and ghost are prevented by preventing deterioration in shielding property of the ultraviolet light particularly at a high incident angle.

The present invention provides an optical filter having the following configuration.
[1] An optical filter including:
a substrate; and
a dielectric multilayer film laid on or above at least one major surface of the substrate as an outermost layer, in which
the substrate includes a resin film containing a resin, a UV pigment 1 having a maximum absorption wavelength in 360 nm to 390 nm in the resin, and an IR pigment having a maximum absorption wavelength in 680 nm to 800 nm in the resin, the resin film having a thickness of 3 μm or less, and
the optical filter satisfies all of the following spectral characteristics (i-1) to (i-8):
(i-1) an average transmittance T_{360-400(0)AVE} in a spectral transmittance curve at a wavelength of 360 nm to 400 nm and an incident angle of 0 degrees is 0.5% or less,
(i-2) an average transmittance T_{350-390(50)AVE} in a spectral transmittance curve at a wavelength of 350 nm to 390 nm and an incident angle of 50 degrees is 0.5% or less,
(i-3) an average transmittance T_{400-430(0)AVE} in a spectral transmittance curve at a wavelength of 400 nm to 430 nm and an incident angle of 0 degrees is 35% or more,
(i-4) an average transmittance T_{430-500(0)AVE} in a spectral transmittance curve at a wavelength of 430 nm to 500 nm and an incident angle of 0 degrees is 88% or more,
(i-5) in a spectral transmittance curve at a wavelength of 350 nm to 450 nm and an incident angle of 0 degrees, a wavelength UV50₍₀₎ at which a transmittance is 50% is 400 nm to 430 nm,
(i-6) when an absolute value of a difference between a wavelength UV10₍₀₎ when a transmittance is 10% and a wavelength UV70₍₀₎ when the transmittance is 70% is ΔUV₇₀₋₁₀₀₍₀₎ in the spectral transmittance curve at the wavelength of 350 nm to 450 nm and the incident angle of 0 degrees, and an absolute value of a difference between a wavelength UV10₍₃₀₎ when a transmittance is 10% and a wavelength UV70₍₃₀₎ when the transmittance is 70% is ΔUV₇₀₋₁₀₍₃₀₎ in a spectral transmittance curve at a wavelength of 350 nm to 450 nm and an incident angle of 30 degrees,
an absolute value of a difference between ΔUV₇₀₋₁₀₍₀₎ and ΔUV₇₀₋₁₀₍₃₀₎ is 2.5 nm or less,
(i-7) in a spectral transmittance curve at a wavelength of 600 nm to 700 nm and an incident angle of 0 degrees, a wavelength IR50₍₀₎ at which a transmittance is 50% is 610 nm to 670 nm, and in a spectral transmittance curve at a wavelength of 600 nm to 700 nm and an incident angle of 30 degrees, a wavelength IR50₍₃₀₎ at which a transmittance is 50% is 610 nm to 670 nm, and
(i-8) an absolute value of a difference between the wavelength IR50₍₀₎ and the wavelength IR50₍₃₀₎ is 5 nm or less.

According to the present invention, it is possible to provide an optical filter that has a high transparency of visible light and a high shielding property of near-infrared light and ultraviolet light, and in which flare and ghost are prevented by preventing deterioration in shielding property of the ultraviolet light particularly at a high incident angle.

### BRIEF DESCRIPTION OF DRAWINGS

FIG. 1 is a cross-sectional view schematically illustrating an example of an optical filter according to one embodiment.

FIG. 2 is a cross-sectional view schematically illustrating another example of an optical filter according to one embodiment.

FIG. 3 is a cross-sectional view schematically illustrating another example of an optical filter according to one embodiment.

FIG. 4 is a cross-sectional view schematically illustrating another example of an optical filter according to one embodiment.

FIG. 5 is a diagram showing a spectral internal transmittance curve of a resin film in Example 2-19.

FIG. 6 is a diagram showing a spectral internal transmittance curve of a resin film in Example 2-1.

FIG. 7 is a diagram showing a spectral internal transmittance curve of a resin film in Example 2-8.

FIG. 8 is a diagram showing a spectral transmittance curve of an optical filter in Example 3-18.

FIG. 9 is a diagram showing a spectral transmittance curve of an optical filter in Example 3-1.

FIG. 10 is a diagram showing a spectral transmittance curve of an optical filter in Example 3-6.

### DESCRIPTION OF EMBODIMENTS

Hereinafter, embodiments of the present invention will be described.

In the present description, a near infrared ray absorbing pigment may be abbreviated as a “NTR pigment”, and an ultraviolet absorbing pigment may be abbreviated as a “UV pigment”.

In the present description, a compound represented by a formula (I) is referred to as a compound (I). The same applies to compounds represented by other formulae. A pigment composed of the compound (I) is also referred to as a pigment (I), and the same applies to other pigments. In addition, a group represented by the formula (I) is also referred to as a group (I), and the same applies to groups represented by other formulae.

In the present description, internal transmittance is transmittance obtained by subtracting an influence of interface reflection from measured transmittance, which is represented by a formula {measured transmittance/(100−reflectance)}×100.

In the present description, an absorbance is converted from an (internal) transmittance by a formula of −log₁₀((internal) transmittance/100).

In the present description, transmittance of a substrate and a spectrum of transmittance when a pigment is contained in a resin are all “internal transmittance” even when described as “transmittance”. On the other hand, transmittance measured by dissolving a pigment in a solvent such as dichloromethane, transmittance of a dielectric multilayer film, and transmittance of an optical filter including the dielectric multilayer film are measured transmittance.

In the present description, transmittance of, for example, 90% or more in a specific wavelength region means that the transmittance does not fall below 90% in the entire wavelength region, that is, a minimum transmittance is 90% or more in the wavelength region. Similarly, transmittance of, for example, 1% or less in the specific wavelength region means that the transmittance does not exceed 1% in the entire wavelength region, that is, a maximum transmittance is 1% or less in the wavelength region. The same applies to the internal transmittance. An average transmittance and an average internal transmittance in the specific wavelength region are the arithmetic mean of transmittance and internal transmittance per 1 nm in the wavelength region.

Spectral characteristics can be measured by using an ultraviolet-visible-near-infrared spectrophotometer.

In the present description, the symbol “−” or the word “to” that is used to express a numerical range includes the numerical values before and after the symbol or the word as the upper limit and the lower limit of the range, respectively.

### <Optical Filter>

An optical filter (hereinafter, also referred to as “the filter”) according to one embodiment of the present invention is an optical filter that includes a substrate and a dielectric multilayer film laid on or above at least one major surface of the substrate as an outermost layer, and satisfies specific spectral characteristics to be described below. Here, the substrate includes a resin film that contains a resin, a UV pigment 1 having a maximum absorption wavelength in 360 nm to 390 nm in the resin, and an IR pigment having a maximum absorption wavelength in 680 nm to 800 nm in the resin, and that has a thickness of 3 μm or less.

Reflection characteristics of the dielectric multilayer film and absorption characteristics of the pigment in the resin film allow the optical filter as a whole to achieve an excellent transparency in a visible light region and an excellent shielding property in a near-ultraviolet light and near-infrared light region. In particular, when the substrate contains the ultraviolet ray absorbing pigment or the near infrared ray absorbing pigment, a change in spectral characteristics of the dielectric multilayer film at a high incident angle, for example, an occurrence of a light leak in an ultraviolet region or a near infrared region can be prevented by the absorption characteristics of the substrate. Each of the pigments and the resin will be described later.

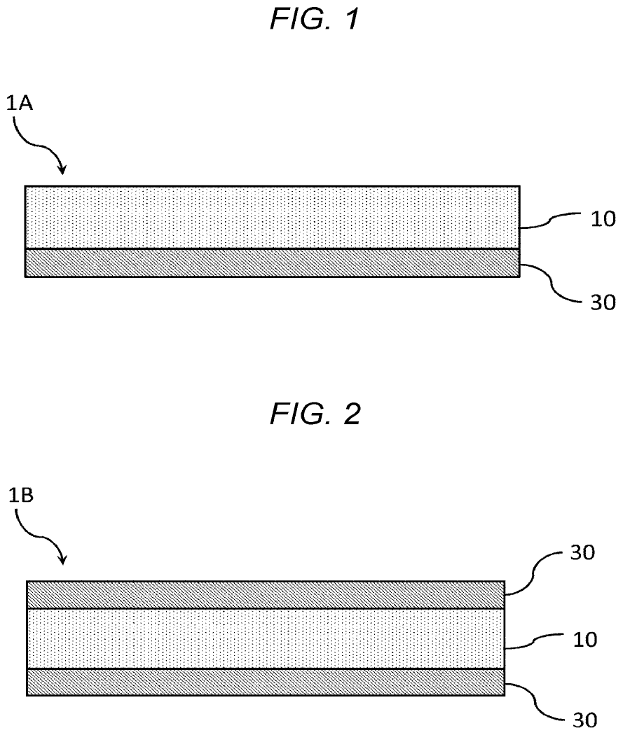

A configuration example of the filter will be described with reference to the drawings. FIGS. 1 to 4 are cross-sectional views schematically illustrating examples of the optical filter according to one embodiment.

An optical filter 1A illustrated in FIG. 1 is an example in which a dielectric multilayer film 30 is provided on one major surface of a substrate 10. Note that “including a specific layer on or above a major surface of a substrate” is not limited to a case where the layer is provided in contact with a major surface of the substrate, and includes a case where another functional layer is provided between the substrate and the layer.

An optical filter 1B illustrated in FIG. 2 is an example in which dielectric multilayer films 30 are provided on both major surfaces of a substrate 10.

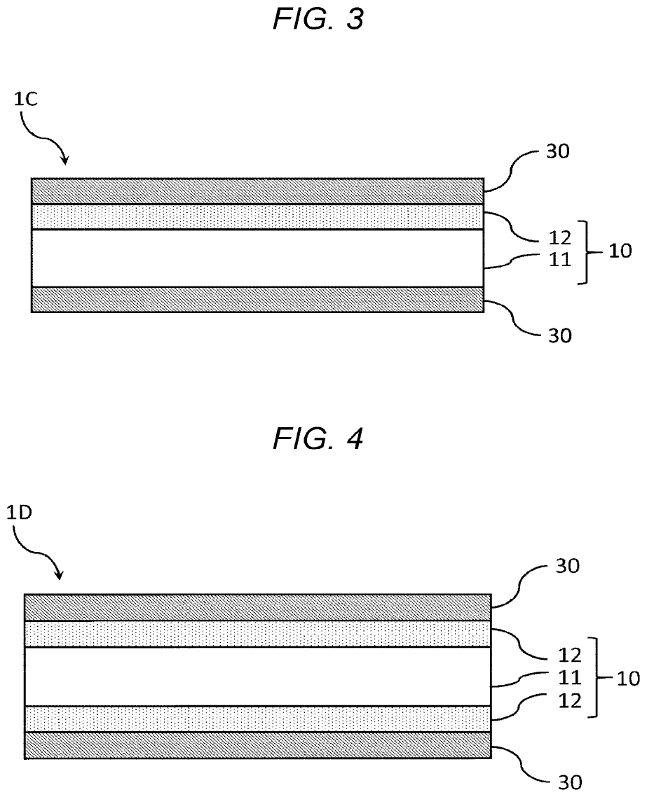

An optical filter 1C illustrated in FIG. 3 is an example in which a substrate 10 includes a support 11 and a resin film 12 laid on one major surface of the support 11. The optical filter 1C further includes dielectric multilayer films 30 on a resin film 12 and on a major surface of the support 11 on which the resin film 12 is not laid.

An optical filter 1D illustrated in FIG. 4 is an example in which a substrate 10 includes a support 11 and resin films 12 laid on both major surfaces of the support 11. The optical filter 1D further includes dielectric multilayer films 30 on each of the resin films 12.

The optical filter of the present invention satisfies all of the following spectral characteristics (i-1) to (i-8):
(i-1) an average transmittance T_{360-400(0)AVE} in a spectral transmittance curve at a wavelength of 360 nm to 400 nm and an incident angle of 0 degrees is 0.5% or less,
(i-2) an average transmittance T_{350-390(50)AVE} in a spectral transmittance curve at a wavelength of 350 nm to 390 nm and an incident angle of 50 degrees is 0.5% or less,
(i-3) an average transmittance T_{400-430(0)AVE} in a spectral transmittance curve at a wavelength of 400 nm to 430 nm and an incident angle of 0 degrees is 35% or more,
(i-4) an average transmittance T_{430-500(0)AVE} in a spectral transmittance curve at a wavelength of 430 nm to 500 nm and an incident angle of 0 degrees is 88% or more,
(i-5) in a spectral transmittance curve at a wavelength of 350 nm to 450 nm and an incident angle of 0 degrees, a wavelength UV50₍₀₎ at which a transmittance is 50% is 400 nm to 430 nm,
(i-6) when an absolute value of a difference between a wavelength UV10₍₀₎ when a transmittance is 10% and a wavelength UV70₍₀₎ when the transmittance is 70% is ΔUV₇₀₋₁₀₍₀₎ in the spectral transmittance curve at the wavelength of 350 nm to 450 nm and the incident angle of 0 degrees, and an absolute value of a difference between a wavelength UV10₍₃₀₎ when a transmittance is 10% and a wavelength UV70₍₃₀₎ when the transmittance is 70% is ΔUV₇₀₋₁₀₍₃₀₎ in a spectral transmittance curve at a wavelength of 350 nm to 450 nm and an incident angle of 30 degrees,
an absolute value of a difference between ΔUV₇₀₋₁₀₍₀₎ and ΔUV₇₀₋₁₀₍₃₀₎ is 2.5 nm or less,
(i-7) in a spectral transmittance curve at a wavelength of 600 nm to 700 nm and an incident angle of 0 degrees, a wavelength IR50₍₀₎ at which a transmittance is 50% is 610 nm to 670 nm, and in a spectral transmittance curve at a wavelength of 600 nm to 700 nm and an incident angle of 30 degrees, a wavelength IR50₍₃₀₎ at which a transmittance is 50% is 610 nm to 670 nm, and
(i-8) an absolute value of a difference between the wavelength IR50₍₀₎ and the wavelength IR50₍₃₀₎ is 5 nm or less.

The filter satisfying all of the spectral characteristics (i-1) to (i-8) is an optical filter that maintains a good transparency of visible light, particularly a transparency of blue light as shown in characteristics (i-3) to (i-4), and prevents deterioration in shielding property of ultraviolet light particularly at a high incident angle as shown in characteristics (i-1) and (i-2).

Satisfying the spectral characteristic (i-1) means that a light shielding property in an ultraviolet light region having a wavelength of 360 nm to 400 nm is high. T_{360-400(0)AVE} is preferably 0.4% or less.

In order to satisfy the spectral characteristic (i-1), for example, a pigment having a high absorption ability in a near-ultraviolet light region may be used.

Satisfying the spectral characteristic (i-2) means that in an ultraviolet light region having a wavelength of 350 nm to 390 nm, the light leak is difficult to occur even at a high incident angle, and a light shielding property is high. T_{350-390(50)AVE} is preferably 0.4% or less.

In order to satisfy the spectral characteristic (i-2), for example, a pigment having a high absorption ability in the near-ultraviolet light region may be used.

Satisfying the spectral characteristic (i-3) means an excellent transparency of blue light before a UV absorption start band of a wavelength of 400 nm to 430 nm. T_{400-430(0)AVE} is preferably 37% or more, and more preferably 38% or more.

In order to satisfy the spectral characteristic (i-3), for example, a UV pigment having an excellent steepness and an IR pigment having a high transmittance in a blue color band may be used.

Satisfying the spectral characteristic (i-4) means an excellent transparency in a visible light region, particularly in a blue color band. T_{430-500(0)AVE} is preferably 89% or more, and more preferably 90% or more.

In order to satisfy the spectral characteristic (i-4), for example, a UV pigment or an IR pigment that have a high transmittance in a visible light band may be used.

Satisfying the spectral characteristic (i-5) means an excellent light shielding property in an ultraviolet light region and an excellent transparency in the visible light region. The wavelength UV50₍₀₎ is preferably 400 nm to 430 nm.

In order to satisfy the spectral characteristic (i-5), for example, a UV pigment having a maximum absorption wavelength in an appropriate wavelength range may be used, or a cut edge of the dielectric multilayer film as a reflection layer may be adjusted.

In the spectral characteristic (i-6), ΔUV₇₀₋₁₀₍₀₎ and ΔUV₇₀₋₁₀₍₃₀₎ represent steepness (rise) of a transmittance curve around a UV absorption start band of a wavelength 350 nm to 450 nm at incident angles of 0 degrees and 30 degrees.

It means that by satisfying the spectral characteristic (i-6), around the UV absorption start band of the wavelength of 350 nm to 450 nm, there is fewer a shift in the steepness of the transmittance curve even at a high incident angle, and color reproducibility is excellent.

The absolute value of the difference between ΔUV₇₀₋₁₀₍₀₎ and ΔUV₇₀₋₁₀₍₃₀₎ is preferably 2.0 nm or less.

In order to satisfy the spectral characteristic (i-6), for example, a UV pigment having a maximum absorption wavelength in an appropriate wavelength range and an excellent in steepness may be used.

It means that by satisfying the spectral characteristics (i-7) and (i-8), a light shielding property in a near-infrared light region and a transparency in the visible light region are excellent, and around a near infrared absorption start band, a shift in the transmittance curve is small even at a high incident angle and color reproducibility is excellent.

The wavelength IR50₍₀₎ is preferably 620 nm to 660 nm.

The wavelength IR50₍₃₀₎ is preferably 620 nm to 660 nm.

The absolute value of the difference between the wavelength IR50₍₀₎ and the wavelength IR50₍₃₀₎ is preferably 4 nm or less.

In order to satisfy the spectral characteristics (i-7) and (i-8), for example, an IR pigment having a maximum absorption wavelength in an appropriate wavelength range may be used.

The optical filter according to the present invention preferably further satisfies the following spectral characteristic (i-9):
(i-9) the absolute value of the difference between the wavelength UV10₍₀₎ and the wavelength UV70₍₀₎ is 13 nm or less.

It means that by satisfying the spectral characteristic (i-9), a slope of a spectral transmittance curve is steep from a near-ultraviolet light region, which is a light shielding region, to a visible light region, which is a transmission region, and a high shielding property in the near-ultraviolet light region and a high transparency in the visible light region can be achieved at the same time.

The absolute value of the difference between the wavelength UV10₍₀₎ and the wavelength UV70₍₀₎ is more preferably 12 nm or less.

In order to satisfy the spectral characteristic (i-9), for example, a UV pigment having an excellent steepness may be used.

The optical filter of the present invention preferably further satisfies the following spectral characteristics (i-10) and (i-11).
(i-10) a maximum transmittance T_{360-400(0)MAX} in the spectral transmittance curve at the wavelength of 360 nm to 400 nm and the incident angle of 0 degrees is 5% or less,
(i-11) a maximum transmittance T_{350-390(50)MAX} in the spectral transmittance curve at the wavelength of 350 nm to 390 nm and the incident angle of 50 degrees is 5% or less.

It means that by satisfying the spectral characteristic (i-10), the light shielding property in the ultraviolet light region having the wavelength of 360 nm to 400 nm is high. T_{360-400(0)MAX} is preferably 4% or less.

In order to satisfy the spectral characteristic (i-10), for example, a pigment having a high absorption ability in the near-ultraviolet light region may be used.

It means that by satisfying the spectral characteristic (i-11), in the ultraviolet light region having the wavelength of 350 nm to 390 nm, the light leak is difficult to occur even at the high incident angle, and the light shielding property is high. T_{350-390(50)MAX} is preferably 4% or less.

In order to satisfy the spectral characteristic (i-11), for example, a pigment having a high absorption ability in the near-ultraviolet light region may be used.

Hereinafter, the substrate and the dielectric multilayer film will be described. The filter is designed such that, for example, the substrate has an absorption ability for ultraviolet light and near-infrared light, and each of the above spectral characteristics (i-1) to (i-8) is satisfied due to the absorption characteristics of the substrate and the reflection characteristics of the dielectric multilayer film.

### <Substrate>

In the optical filter according to the present invention, the substrate includes the resin film containing the resin, the UV pigment 1, and the IR pigment.

### <Resin Film>

The resin film preferably satisfies all of the following spectral characteristics (iii-1) to (iii-9):
(iii-1) an internal transmittance T₃₆₀ at a wavelength of 360 nm is 25% or less,
(iii-2) an internal transmittance T₃₇₀ at a wavelength of 370 nm is 10% or less,
(iii-3) an internal transmittance T₃₈₀ at a wavelength of 380 nm is 4% or less,
(iii-4) an average internal transmittance T_{360-400AVE} in a spectral transmittance curve at a wavelength of 360 nm to 400 nm is 15% or less,
(iii-5) an average internal transmittance T_{400-430AVE} in a spectral transmittance curve at a wavelength of 400 nm to 430 nm is 40% or more,
(iii-6) an average internal transmittance T_{430-500AVE} in a spectral transmittance curve at a wavelength of 430 nm to 500 nm is 90% or more,
(iii-7) in a spectral transmittance curve at a wavelength of 350 nm to 450 nm, an absolute value of a difference between a wavelength UV10 when an internal transmittance is 10% and a wavelength UV70 when an internal transmittance is 70% is 17 nm or less,
(iii-8) an internal transmittance T₇₀₀ at a wavelength of 700 nm is 5% or less, and
(iii-9) in a spectral transmittance curve at a wavelength of 600 nm to 700 nm, a wavelength IR50 at which an internal transmittance is 50% is 610 nm to 670 nm.

By satisfying the spectral characteristics (iii-1) to (iii-4), it is possible to obtain an optical filter which has a high light shielding property in the near-ultraviolet light region and in which a near-ultraviolet light shielding property does not decrease even at a high incident angle.

The internal transmittance T₃₆₀ is more preferably 20% or less.

The internal transmittance T₃₇₀ is more preferably 7% or less.

The internal transmittance T₃₈₀ is more preferably 3.5% or less.

The average internal transmittance T_{360-400AVE} is more preferably 13% or less.

By satisfying the spectral characteristics (iii-5) and (iii-6), an optical filter having an excellent transparency in visible light, particularly in a blue light region, is obtained.

T_{400-430AVE} is more preferably 42% or more.

T_{430-500AVE} is more preferably 92% or more.

By satisfying the spectral characteristic (iii-7), an optical filter having an excellent steepness is obtained.

An absolute value of a difference between the wavelength UV10 and the wavelength UV70 is more preferably 15 nm or less.

By satisfying the spectral characteristics (iii-8) and (iii-9), an optical filter having an excellent light shielding property in the near-infrared light region is obtained.

The internal transmittance T₇₀₀ is more preferably 3% or less.

The wavelength IR50 is more preferably 620 nm to 670 nm.

In order to satisfy the spectral characteristics (iii-1) to (ii-7), a compound represented by a formula (S) to be described later may be used as a UV pigment.

In order to satisfy the spectral characteristics (iii-8) to (iii-9), a squarylium compound, which will be described later, may be used as the IR pigment.

### <UV Pigment>

The UV pigment 1 is a near ultraviolet ray absorbing pigment having the maximum absorption wavelength in 360 nm to 390 nm in the resin. By containing such a pigment, the ultraviolet light can be effectively cut.

The UV pigment 1 preferably has specific spectral characteristics in the resin. Specifically, it is preferable to satisfy all of the following spectral characteristics (ii-1) to (ii-3) in a spectral internal transmittance curve of a coating film obtained by dissolving the UV pigment 1 in the resin and coating an alkali glass plate with a mixture. The resin is preferably the same as the resin contained in the substrate.
(ii-1) an absorbance at a maximum absorption wavelength is 0.1 (/mass % Lm) or more,
(ii-2) in the spectral internal transmittance curve of the coating film in which an internal transmittance at a maximum absorption wavelength is 1%, an average internal transmittance T_{350-400AVE} at a wavelength of 350 nm to 400 nm is 13% or less, and
(ii-3) in the spectral internal transmittance curve of the coating film normalized such that the internal transmittance at the maximum absorption wavelength is 1%, an absolute value of a difference between a wavelength UV10 when an internal transmittance at a wavelength of 350 nm to 450 nm is 10% and a wavelength UV70 when an internal transmittance is 70% is 10 nm or less.

In the spectral characteristic (ii-1), the absorbance (/mass %·μm) is an absorbance per 1 mass % of pigment content and 1 μm of film thickness. When the absorbance is 0.1 or more, it means that the UV pigment 1 has a high absorption ability, and a sufficient light shielding property can be achieved even with a small content.

The absorbance is preferably 0.12 (/mass %·μm) or more.

The spectral characteristic (ii-2) means that light having a wavelength of 350 nm to 400 nm can be widely absorbed.

T_{350-400AVE} is preferably 11% or less.

The spectral characteristic (ii-3) means that a slope of the spectral transmittance curve from a near-ultraviolet light region, which is a light shielding region, to a visible light region, which is a transmission region, is steep.

The absolute value of the difference between the wavelength UV10 and the wavelength UV70 is preferably 9.5 nm or less.

As the UV pigment 1, a cyanine compound represented by the following formula (S) is preferable from the viewpoint of easily satisfying the spectral characteristics (ii-1) to (ii-3) and from the viewpoint of having an effect of preventing a deterioration of the IR pigment.

In general, the IR pigment is easily deteriorated by being used in combination with the UV pigment, but the deterioration can be prevented by using the cyanine compound represented by the formula (S) as the UV pigment.

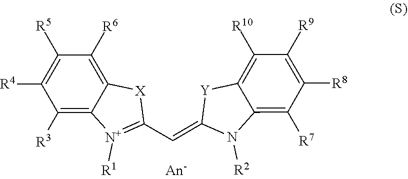

[Symbols in the above formula are as follows.
R¹ and R² each independently represent an alkyl group having 1 to 4 carbon atoms;
R³ to R¹⁰ each independently represent a hydrogen atom, a halogen atom, a sulfo group, a hydroxyl group, a cyano group, a nitro group, a carboxy group, a phenyl group, an alkyl group having 1 to 10 carbon atoms which may have a substituent, an alkoxy group having 1 to 10 carbon atoms which may have a substituent, an acyloxy group having 1 to 10 carbon atoms which may have a substituent, —NR¹¹R¹² (R¹¹ and R¹² are each independently a hydrogen atom, an alkyl group having 1 to 10 carbon atoms which may have a substituent, —C(═O)—R¹³ (R¹³ is an alkyl group having 1 to 10 carbon atoms or an aryl group having 6 to 11 carbon atoms, which may have a substituent), —SO₂—R¹⁴ (R¹⁴ is an alkyl group having 1 to 10 carbon atoms or an aryl group having 6 to 11 carbon atoms, which may have a substituent)), or —SO₂—R¹⁵ (R¹⁵ is an alkyl group having 1 to 10 carbon atoms or an aryl group having 6 to 11 carbon atoms, which may have a substituent, or —NR¹⁶R¹⁷ (R¹⁶ and R¹⁷ each independently represent a hydrogen atom or an alkyl group having 1 to 10 carbon atoms which may have a substituent));
X and Y each independently represent 0, S, or —C(CH₃)₂; and
An⁻ represents a monovalent anion.]

R¹ and R² are each independently preferably a methyl group or an ethyl group from the viewpoint of ease of synthesis.

Examples of the substituent in each of R³ to R¹⁰ include an alkyl group, a halogen atom, or a phenyl group from the viewpoint of ease of synthesis, and among them, a t-butyl group is preferred from the viewpoint of solubility in a resin. Carbon atoms in the substituent is included in carbon atoms in of each of R³ to R¹⁰.

From the viewpoint of ease of synthesis, R³ is preferably a hydrogen atom.

R⁴ is preferably a hydrogen atom, a halogen atom, a cyano group, a nitro group, a phenyl group, an alkyl group having 1 to 10 carbon atoms which may have a substituent, —NH—C(═O)—R¹³ (R¹³ is preferably an alkyl group having 1 to 10 carbon atoms), —SO₂—R¹⁵ (R¹⁵ is preferably an alkyl group having 1 to 10 carbon atoms), and particularly preferably an alkyl group having 4 to 10 carbon atoms from the viewpoint of solubility in the resin. Among them, a t-butyl group is particularly preferable.

R⁵, R⁶, and R⁷ are preferably a hydrogen atom from the viewpoint of ease of synthesis.

From the viewpoint of ease of synthesis and a maximum absorption wavelength range, R⁸ is preferably a hydrogen atom, an alkyl group having 1 to 10 carbon atoms, a halogen atom, or a phenyl group.

From the viewpoint of ease of synthesis and a maximum absorption wavelength range, R⁹ and R¹⁰ are each independently preferably a hydrogen atom, an alkyl group having 1 to 4 carbon atoms, or a halogen atom.

X and Y are preferably O from the viewpoint that a maximum absorption wavelength of a pigment (S) is in an appropriate wavelength region.

As An⁻, PF₆⁻, [Rf—SO₂]⁻, [N(Rf—SO₂)₂]⁻, or BF₄⁻ is preferable. Rf represents an alkyl group substituted with at least one fluorine atom, preferably a perfluoroalkyl group having 1 to 8 carbon atoms, and particularly preferably —CF₃. Due to a structure of an anion, a UV pigment compound (S) having an excellent light resistance is obtained.

More specifically, in the formula (S), compounds in which atoms or groups bonded to skeletons are shown in the following table can be described.

Incidentally, tBu means a tertiary butyl group, and Ph means a phenyl group.

TABLE 1

| Pigment | | | | | | | | | | | | |
|---|---|---|---|---|---|---|---|---|---|---|---|---|
| abbreviation | R¹ | R² | R³ | R⁴ | R⁵ | R⁶ | R⁷ | R⁸ | R⁹ | R¹⁰ | X | Y |
| (S-1) | CH₃ | CH₃ | H | H | H | H | H | H | H | H | O | O |
| (S-2) | C₂H₅ | C₂H₅ | H | H | H | H | H | H | H | H | O | O |
| (S-3) | CH(CH₃)₂ | CH(CH₃)₂ | H | H | H | H | H | H | H | H | O | O |
| (S-4) | CH₃ | CH₃ | H | CH₃ | H | H | H | CH₃ | H | H | O | O |
| (S-5) | CH₃ | CH₃ | H | H | CH₃ | H | H | H | CH₃ | H | O | O |
| (S-6) | CH₃ | CH₃ | H | tBu | H | H | H | H | H | H | O | O |
| (S-7) | CH₃ | C₂H₅ | H | tBu | H | H | H | H | H | H | O | O |
| (S-8) | CH₃ | CH₃ | H | tBu | H | H | H | tBu | H | H | O | O |
| (S-9) | CH₃ | CH₃ | H | Ph | H | H | H | Ph | H | H | O | O |
| (S-10) | CH₃ | CH₃ | H | F | H | H | H | F | H | H | O | O |
| (S-11) | CH₃ | CH₃ | H | CF₃ | H | H | H | CF₃ | H | H | O | O |
| (S-12) | CH₃ | CH₃ | H | H | OCH₃ | H | H | H | H | H | O | O |
| (S-13) | CH₃ | CH₃ | H | CN | H | H | H | H | H | H | O | O |
| (S-14) | CH₃ | CH₃ | H | NO₂ | H | H | H | H | H | H | O | O |
| (S-15) | CH₃ | CH₃ | H | NHCOCH(C₂H₅) | H | H | H | H | H | H | O | O |
| | | | | (C₄II₉) | | | | | | | | |
| (S-16) | CH₃ | CH₃ | H | SO₂CH₃ | H | H | H | H | H | H | O | O |
| (S-17) | CH₃ | CH₃ | H | H | H | H | H | H | H | H | C(CH₃)₂ | O |
| (S-18) | CH₃ | CH₃ | H | H | H | H | H | H | H | H | S | O |

As the compound (S), a compound (S-7) and a compound (S-8) in which an anion is BF₄⁻, PF₆⁻, or N(SO₂CF₃)₂⁻ are preferable, and a compound (S-8) in which the anion is BF₄⁻, PF₆⁻, or N(SO₂CF₃)₂⁻ and the compound (S-7) in which the anion is PF₆⁻ are particularly preferable from the viewpoint of solubility in resin and ease of synthesis.

The compound (S) can be produced by a known method described, for example, in JP2011-102841A and JP4702731B.

As the UV pigment in the resin film, the UV pigment 1 may be used alone, or two or more types thereof may be used in combination, but from the viewpoint of being able to shield the ultraviolet light region more efficiently with a small content, it is preferable to use two or more types having different maximum absorption wavelengths in combination.

The resin film preferably further contains a UV pigment 2 which has a maximum absorption wavelength in 390 nm to 405 nm in the resin, and the maximum absorption wavelength is larger than that of UV pigment 1 by 10 nm or more.

The UV pigment 2 is particularly preferably a merocyanine pigment represented by the following formula (M).

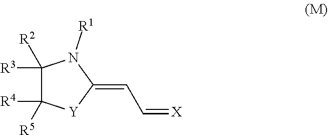

Symbols in the formula (M) are as follows.

R¹ represents a monovalent hydrocarbon group having 1 to 12 carbon atoms which may have a substituent.

The substituent is preferably an alkoxy group, an acyl group, an acyloxy group, a cyano group, a dialkylamino group, or a chlorine atom. The above-mentioned alkoxy group, acyl group, acyloxy group and dialkylamino group preferably have 1 to 6 carbon atoms.

Specifically, R¹ which does not have a substituent is preferably an alkyl group having 1 to 12 carbon atoms in which a part of hydrogen atoms may be substituted with an aliphatic ring, an aromatic ring, or an alkenyl group, a cycloalkyl group having 3 to 8 carbon atoms in which a part of hydrogen atoms may be substituted with an aromatic ring, an alkyl group, or an alkenyl group, or an aryl group having 6 to 12 carbon atoms in which a part of hydrogen atoms may be substituted with an aliphatic ring, an alkyl group, or an alkenyl group.

In a case where R¹ is an unsubstituted alkyl group, the alkyl group may be linear or branched, and the number of carbon atoms thereof is more preferably 1 to 6.

In a case where R¹ is an alkyl group having 1 to 12 carbon atoms in which a part of hydrogen atoms is substituted with an aliphatic ring, an aromatic ring or an alkenyl group, an alkyl group having 1 to 4 carbon atoms and having a cycloalkyl group having 3 to 6 carbon atoms or an alkyl group having 1 to 4 carbon atoms substituted with a phenyl group is more preferable, and an alkyl group having 1 carbon atom or 2 carbon atoms substituted with a phenyl group is particularly preferable. The alkyl group substituted with an alkenyl group refers to an alkenyl group as a whole but does not have an unsaturated bond between the 1-position and the 2-position, for example, an allyl group, a 3-butenyl group, and the like.

Preferred R¹ is an alkyl group having 1 to 6 carbon atoms in which a part of hydrogen atoms may be substituted with a cycloalkyl group or a phenyl group. Particularly preferred Q¹ is an alkyl group having 1 to 6 carbon atoms, and specific examples thereof include a methyl group, an ethyl group, an n-propyl group, an isopropyl group, an n-butyl group, an isobutyl group, and a t-butyl group.

R² to R⁵ each independently represent a hydrogen atom, a halogen atom, an alkyl group having 1 to 10 carbon atoms, or an alkoxy group having 1 to 10 carbon atoms. The alkyl group and the alkoxy group preferably have 1 to 6 carbon atoms, and more preferably 1 to 4 carbon atoms.

At least one of R² and R³ is preferably an alkyl group, and both are more preferably alkyl groups. In a case where R² and R³ are not alkyl groups, the two are more preferably hydrogen atoms. Both R² and R³ are particularly preferably alkyl groups having 1 to 6 carbon atoms.

At least one of R⁴ and R⁵ is preferably a hydrogen atom, and both are more preferably hydrogen atoms. In a case where R⁴ or R⁵ is not a hydrogen atom, an alkyl group having 1 to 6 carbon atoms is preferable.

Y represents a methylene group or an oxygen atom substituted with R⁶ and R⁷.

R⁶ and R⁷ each independently represent a hydrogen atom, a halogen atom, an alkyl group having 1 to 10 carbon atoms, or an alkoxy group having 1 to 10 carbon atoms.

X represents any of divalent groups represented by the following formulae (X1) to (X5).

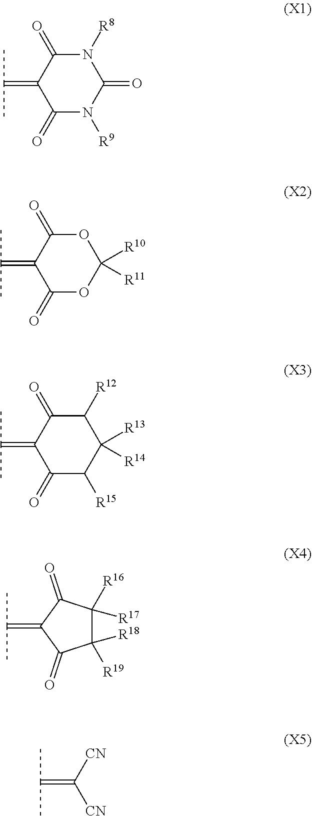

R⁸ and R⁹ each independently represent a monovalent hydrocarbon group having 1 to 12 carbon atoms which may have a substituent, and R¹⁰ to R¹⁹ each independently represent a hydrogen atom or a monovalent hydrocarbon group having 1 to 12 carbon atoms which may have a substituent.

Examples of the substituents of R⁸ to R¹⁹ include the same substituents as the substituent of R¹, and preferred embodiments thereof are also the same. In a case where R⁸ to R¹⁹ are hydrocarbon groups which do not have a substituent, examples thereof include the same aspects as those of R¹ which does not have a substituent.

In the formula (X1), R⁸ and R⁹ may be different groups, but are preferably the same group. In a case where R⁸ and R⁹ represent unsubstituted alkyl groups, the alkyl groups may be linear or branched, and the number of carbon atoms thereof is more preferably 1 to 6.

Preferred R⁸ and R⁹ are both alkyl groups having 1 to 6 carbon atoms in which a part of hydrogen atoms may be substituted with a cycloalkyl group or a phenyl group. Particularly preferred R⁸ and R⁹ both represent alkyl groups having 1 to 6 carbon atoms, and specific examples thereof include a methyl group, an ethyl group, an n-propyl group, an isopropyl group, an n-butyl group, an isobutyl group, and a t-butyl group.

In the formula (X2), both R¹⁰ and R¹¹ are more preferably alkyl groups having 1 to 6 carbon atoms, and particularly preferably the same alkyl group.

In the formula (X3), both R¹² and R¹⁵ are preferably hydrogen atoms or alkyl groups having 1 to 6 carbon atoms which do not have a substituent. Both R¹³ and R¹⁴, which are two groups bonded to the same carbon atom, are preferably hydrogen atoms or alkyl groups having 1 to 6 carbon atoms.

All of R¹⁶ and R¹⁷ as well as R¹⁸ and R¹⁹ in the formula (X4), which are two groups bonded to the same carbon atom, are preferably hydrogen atoms or alkyl groups having 1 to 6 carbon atoms.

A compound represented by the formula (M) is preferably a compound in which Y is an oxygen atom and X is a group (X1), a group (X2), or a group (X5), or a compound in which Y is an unsubstituted methylene group and X is a group (X1), a group (X2), or a group (X5).

Specific examples of the compound (M) include compounds shown in the following table.

TABLE 2

| Pigment | | | | | | | | |
|---|---|---|---|---|---|---|---|---|
| abbreviation | R¹ | R² and R³ | R⁴ and R⁵ | X | Y | R⁶ and R⁷ | R⁸ and R⁹ | R¹⁰ and R¹¹ |
| (M-1) | CH₃ | H | H | X1 | O | — | CH₃ | — |
| (M-2) | CH₃ | CH₃ | H | X1 | O | — | CH₃ | — |
| (M-3) | C₂H₅ | H | H | X1 | O | — | CH₃ | — |
| (M-4) | C₂H₅ | CH₃ | H | X1 | O | — | CH₃ | — |
| (M-5) | C₃H₇ | H | H | X1 | O | — | CH₃ | — |
| (M-6) | C₃H₇ | CH₃ | H | X1 | O | — | CH₃ | — |
| (M-7) | CH(CH₃)₂ | H | H | X1 | O | — | CH₃ | — |
| (M-8) | CH(CH₃)₂ | CH₃ | H | X1 | O | — | CH₃ | — |
| (M-9) | CH₃ | H | H | X1 | —C(R⁶)(R⁷)— | H | CH₂CH(CH₃)₂ | — |
| (M-10) | C₂H₅ | H | H | X1 | —C(R⁶)(R⁷)— | H | CH₂CH(CH₃)₂ | — |
| (M-11) | C₃H₇ | H | H | X1 | —C(R⁶)(R⁷)— | H | CH₂CH(CH₃)₂ | — |
| (M-12) | CII(CII₃)₂ | II | II | X1 | —C(R⁶)(R⁷)— | II | CII₂CII(CII₃)₂ | — |
| (M-13) | CH₃ | CH₃ | H | X2 | O | — | — | CH₃ |
| (M-14) | C₂H₅ | CH₃ | H | X2 | O | — | — | CH₃ |
| (M-15) | C₃H₇ | CH₃ | H | X2 | O | — | — | CH₃ |
| (M-16) | CH(CH₃)₂ | CH₃ | H | X2 | O | — | — | CH₃ |
| (M-17) | CH₃ | H | H | X5 | —C(R⁶)(R⁷)— | H | — | — |
| (M-18) | C₂H₅ | H | H | X5 | —C(R⁶)(R⁷)— | H | — | — |
| (M-19) | C₃H₇ | H | H | X5 | —C(R⁶)(R⁷)— | H | — | — |
| (M-20) | CH(CH₃)₂ | H | H | X5 | —C(R⁶)(R⁷)— | H | — | — |

As the compound (M), a compound (M-2), a compound (M-8), a compound (M-9), a compound (M-13), and a compound (M-20) are preferable from the viewpoint that solubility in a resin and a maximum absorption wavelength are appropriate.

The compound (M) can be produced, for example, by a known method described in JP6504176B.

A content of the UV pigment 1 in the resin film is preferably in a range in which a product of the content of the UV pigment 1 and a thickness of the resin film is preferably 15 (mass %·μm) or less, more preferably 14.5 (mass %·μm) or less, and particularly preferably 14.0 (mass %·μm) or less. When an addition amount of the UV pigment 1 is increased, resin characteristics are deteriorated, and as a result, adhesion to the dielectric multilayer film or a glass may be deteriorated. Further, a glass transition temperature of the resin may decrease, and a heat resistance may be concerned. When the product of a content of a pigment and the thickness of the resin film is in the above range, such a problem can be prevented. Further, from the viewpoint of satisfying desired spectral characteristics, the product of the content and the thickness is preferably 3.0 (mass %·μm) or more, and more preferably 5.0 (mass %·μm) or more.

From the viewpoint of satisfying the above range, the content of the UV pigment 1 in the resin film is preferably 2.0 to 15.0 parts by mass, and more preferably 3.0 to 14.0 parts by mass with respect to 100 parts by mass of the resin. Within this range, the above problem can be avoided without deteriorating the resin characteristics.

When the resin film contains the UV pigment 1 and the UV pigment 2, for the same reason, a content of the UV pigment 2 is preferably set such that a product of a total content of the UV pigment 1 and the UV pigment 2 and the thickness of the resin film is 15 (mass %·μmin) or less, more preferably 14.5 (mass %·μm) or less, and particularly preferably 14.0 (mass %·μm) or less.

The content of the UV pigment 2 in the resin film is preferably 2.0 to 13.0 parts by mass, and more preferably 3.0 to 11.0 parts by mass with respect to 100 parts by mass of the resin.

The total content of the UV pigment 1 and the UV pigment 2 in the resin film is preferably 3.0 to 15.0 parts by mass, and more preferably 5.0 to 14.0 parts by mass with respect to 100 parts by mass of the resin.

### <IR Pigment>

The IR pigment is a near infrared ray absorbing pigment having a maximum absorption wavelength in 680 nm to 800 nm in the resin. By containing such a pigment, infrared light can be effectively cut.

The IR pigment is preferably at least one selected from the group consisting of a squarylium pigment, a cyanine pigment, a phthalocyanine pigment, a naphthalocyanine pigment, a dithiol metal complex pigment, an azo pigment, a polymethine pigment, a phthalide pigment, a naphthoquinone pigment, an anthraquinone pigment, an indophenol pigment, a pyrylium pigment, a thiopyrylium pigment, a croconium pigment, a tetradehydrocholine pigment, a triphenylmethane pigment, an aminum pigment, and a diimmonium pigment.

The IR pigment preferably contains at least one pigment selected from a squarylium pigment, a phthalocyanine pigment, and a cyanine pigment. Among these IR pigments, a squarylium pigment and a cyanine pigment are preferable from a spectroscopic viewpoint, and a phthalocyanine pigment is preferable from the viewpoint of durability.

A content of the NIR pigment in the resin film is preferably 5 parts by mass to 25 parts by mass, and more preferably 5 parts by mass to 20 parts by mass with respect to 100 parts by mass of the resin.

### <Configuration of Substrate>

The substrate in the filter may have a single-layer structure or a multiple-layer structure. Further, a material of the substrate may be an organic material or an inorganic material as long as the material is a transparent material that transmits visible light of 400 nm to 700 nm, and is not particularly limited.

In the case in which the substrate has a single-layer structure, the substrate is preferably a resin substrate formed of a resin film containing a resin, a UV pigment, and an NIR pigment.

In the case in which the substrate has a multiple-layer structure, the substrate preferably has a structure in which resin films each containing a UV pigment and an NIR pigment are laid on or above at least one major surface of a support. At this time, the support is preferably made of a transparent resin or a transparent inorganic material.

The resin is preferably a transparent resin, and examples thereof include a polyester resin, an acrylic resin, an epoxy resin, an enethiol resin, a polycarbonate resin, a polyether resin, a polyarylate resin, a polysulfone resin, a polyethersulfone resin, a polyparaphenylene resin, a polyarylene ether phosphine oxide resin, a polyamide resin, a polyimide resin, a polyamide-imide resin, a polyolefin resin, a cyclic olefin resin, a polyurethane resin, a polystyrene resin, and the like. These resins may be used alone, or may be used by mixing two or more kinds thereof. Among them, a polyimide resin is preferable from the viewpoint of excellent visible light transmittance and a high glass transition temperature of the resin, which makes it difficult to cause thermal deterioration of the pigment.

The transparent inorganic material is preferably a glass or a crystalline material.

Examples of a glass usable for the support include an absorption type glass (near infrared ray absorption glass) containing copper ions in a fluorophosphate glass, a phosphate glass, or the like, a soda-lime glass, a borosilicate glass, a non-alkali glass, and a quartz glass. The glass is preferably an absorption glass depending on the purpose, and from the viewpoint of absorbing the infrared light, a phosphate glass or a fluorophosphate glass is preferable. When it is desired to take in a large amount of red light (600 nm to 700 nm), an alkali glass, a non-alkali glass, and a quartz glass are preferable. The “phosphate glass” also includes a silicophosphate glass in which a part of a skeleton of glass is formed of SiO₂.

As the glass, a chemically strengthened glass may be used which is obtained by exchanging alkali metal ions (for example, Li ions and Na ions) having a small ionic radius present on a major surface of a glass plate with alkali ions having a larger ionic radius (for example, Na ions or K ions with respect to Li ions and K ions with respect to Na ions) by ion exchange at a temperature equal to or lower than a glass transition point.

Examples of the crystalline material usable for the support include birefringence crystals such as acrystal, lithium niobate, and sapphire.

The support is preferably made of an inorganic material, and particularly preferably made of a glass or sapphire, from the viewpoint of shape stability related to long-term reliability such as optical characteristics and mechanical characteristics, and from the viewpoint of a handling ability during filter production.

The resin film can be formed by dissolving or dispersing a pigment, a resin or raw material components of the resin, and respective components blended as necessary in a solvent to prepare a coating solution, applying the coating solution to a support, drying the coating solution, and further curing the coating solution as necessary. The support may be a support included in the present filter, or may be a peelable support used only when a resin film is formed. Further, the solvent may be a dispersion medium capable of stably dispersing or a solvent capable of dissolving.

The coating solution may contain a surfactant in order to improve voids due to fine bubbles, depressions due to adhesion of foreign substances and the like, and repelling in a drying process. Further, for the application of the coating solution, for example, a dip coating method, a cast coating method, or a spin coating method can be used. The above-mentioned coating solution is applied onto the support and then dried to form a resin film. Further, in a case where the coating solution contains a raw material component of the transparent resin, a curing process such as thermal curing or photocuring is further performed.

The resin film can also be produced into a film shape by extrusion molding. When the substrate has a single-layer structure (resin substrate) formed of the resin film containing the pigment, the resin film can be used as the substrate as it is. When the substrate has a multiple-layer structure (composite substrate) including the support and the resin film laid on or above at least one major surface of the support, the substrate can be produced by laying the film on the support and integrating the film by thermocompression bonding or the like.

The resin film may be provided in the optical filter by one layer or two or more layers. In the case in which the resin film is provided by two or more layers, each of the layers may have the same configuration or a different configuration.

The thickness of the resin film is 3 μm or less, and preferably 2.5 μm or less. When the thickness of the resin film is in such a range, a uniform film having a small film thickness distribution is easily obtained. Further, from the viewpoint of obtaining desired spectral characteristics, the thickness thereof is preferably 1.0 μm or more. In the case in which the resin film is provided by a plurality of layers, a thickness of each layer preferably satisfies the above range.

A shape of the substrate is not particularly limited, and may be a block shape, a plate shape, or a film shape.

Further, a thickness of the substrate is preferably 300 μm or less, more preferably 50 μm to 300 μm, and particularly preferably 70 μm to 300 μm from the viewpoint of warping and deformation that occur when reliability changes, or handling when the dielectric multilayer film is formed.

When the substrate is the resin substrate containing the resin and the pigment, the thickness of the substrate is preferably 120 μm or less from an advantage of reducing a height, and is preferably 50 μm or more from the viewpoint of reducing warpage at the time of forming the multilayer film. When the substrate is the composite substrate including the support and the resin film, the thickness thereof is preferably 70 μm to 110 μm.

### <Dielectric Multilayer Film>

In the filter, the dielectric multilayer film is laid on or above at least one major surface of the substrate as the outermost layer.

In the filter, it is preferable that at least one of the dielectric multilayer films be designed as a near infrared ray reflection layer (hereinafter, also referred to as a NIR reflection layer). It is preferable that the other the dielectric multilayer film be designed as a NIR reflection layer, a reflection layer having a reflection region other than the near infrared region, or an antireflection layer.

The NIR reflection layer is a dielectric multilayer film designed to shield light in the near infrared region. The NIR reflection layer has, for example, a wavelength selectivity of transmitting the visible light and mainly reflecting light in the near infrared region outside a light shielding region of the resin film. A reflection region of the NIR reflection layer may include a light shielding region in the near infrared region of the resin film. The NIR reflection layer is not limited to have NIR reflection characteristics, and may be appropriately designed in a specification of further shielding light in a wavelength region other than the near infrared region, for example, a near ultraviolet region.

The NIR reflection layer preferably satisfies the following spectral characteristics:
(v-1) an average transmittance T_{360-400(0)AVE} in a spectral transmittance curve at a wavelength of 360 nm to 400 nm and an incident angle of 0 degrees is 1% or less,
(v-2) an average transmittance T_{430-500(0)AVE} in a spectral transmittance curve at a wavelength of 430 nm to 500 nm and an incident angle of 0 degrees is 90% or more,
(v-3) an average transmittance T_{750-1000(0)AVE} in a spectral transmittance curve at a wavelength of 750 nm to 1,000 nm and an incident angle of 0 degrees is 2% or less,
(v-4) in a spectral transmittance curve at a wavelength of 350 nm to 450 nm and an incident angle of 0 degrees, a wavelength UV50 at which a transmittance is 50% is 380 nm to 430 nm, and
(v-5) in a spectral transmittance curve at a wavelength of 650 nm to 750 nm and an incident angle of 0 degrees, a wavelength IR50 at which a transmittance is 50% is 670 nm to 720 nm.

For example, the NIR reflection layer is formed of a dielectric multilayer film in which two or more of a dielectric film having a low refractive index (low refractive index film), a dielectric film having a medium refractive index (medium refractive index film), and a dielectric film having a high refractive index (high refractive index film) are laid.

The high refractive index film preferably has a refractive index of 1.6 or more, and more preferably 2.2 to 2.5. Examples of a material of the high refractive index film include Ta₂O₅, TiO₂, TiO, and Nb₂O₅. Other commercial products thereof include OS50 (Ti₃O₅), OS10 (Ti₄O₇), OA500 (a mixture of Ta₂O₅ and ZrO₂), and OA600 (a mixture of Ta₂O₅ and TiO₂) manufactured by Canon Optron, Inc. Among those, TiO₂ is preferable from the viewpoint of reproducibility in film formability and refractive index, stability, and the like.

The medium refractive index film preferably has a refractive index of 1.6 or more and less than 2.2. Examples of a material of the medium refractive index film include ZrO₂, Nb₂O₅, Al₂O₃, HfO₂, OM-4 and OM-6 (mixtures of Al₂O₃ and ZrO₂) sold by Canon Optron, Inc., OA-100, and H4 and M2 (alumina lanthania) sold by Merck KGaA. Among those, Al₂O₃-based compounds and mixtures of Al₂O₃ and ZrO₂ are preferable from the viewpoint of reproducibility in film formability and refractive index, stability, and the like.

The low refractive index film preferably has a refractive index of less than 1.6, and more preferably 1.45 or more and less than 1.55. Examples of a material of the low refractive index film include SiO₂, SiOₓN_{y}, and MgF₂. Other commercial products thereof include S4F and S5F (mixtures of SiO₂ and AlO₂) manufactured by Canon Optron, Inc. Among those, SiO₂ is preferable from the viewpoint of reproducibility in film formability, stability, economic efficiency, and the like.

Furthermore, it is preferable that transmittance of the NIR reflection layer sharply change in a boundary wavelength region between a transmission region and the light shielding region. For this purpose, the total number of laid layers of the dielectric multilayer film constituting the reflection layer is preferably 15 or more, more preferably 25 or more, and still more preferably 30 or more. However, when the total number of laid layers increases, warpage or the like occurs or a film thickness increases, so that the total number of laid layers is preferably 100 or less, more preferably 75 or less, and still more preferably 60 or less. In addition, the film thickness of the reflection layer is preferably 2 μm to 10 m as a whole.

When the total number of laid layers or the film thickness of the dielectric multilayer film is within the above range, the NIR reflection layer satisfies a requirement for miniaturization and can prevent incident angle dependency while maintaining a high productivity. For formation of the dielectric multilayer film, for example, a vacuum film formation process such as a CVD method, a sputtering method, or a vacuum deposition method, a wet film formation process such as a spraying method or a dipping method, or the like can be used.

The NIR reflection layer may provide a predetermined optical characteristic by one layer (one group of dielectric multilayer films) or may provide a predetermined optical characteristic by two layers. When two or more NIR reflection layers are provided, the respective reflection layers may have the same configuration or different configurations. In a case in which two or more reflection layers are provided, a plurality of reflection layers having different reflection bands are usually provided. In a case in which two reflection layers are provided, one of the reflection layers may be a near infrared reflection layer that shields light in a short wavelength band in the near infrared region, and the other of the reflection layers may be a near infrared and near ultraviolet reflection layer that shields light in both a long wavelength band of the near infrared region and the near ultraviolet region.

Examples of the antireflection layer include a dielectric multilayer film, an intermediate refractive index medium, and a moth-eye structure in which the refractive index gradually changes. Among those, the dielectric multilayer film is preferable from the viewpoint of optical efficiency and productivity. The antireflection layer is obtained by alternately laminating dielectric films in the same manner as the reflection layer.

The filter may include, as another component, for example, a component (layer) that provides absorption by inorganic fine particles or the like that control transmission and absorption of light in a specific wavelength region. Specific examples of the inorganic fine particles include indium tin oxides (ITO), antimony-doped tin oxides (ATO), cesium tungstate, and lanthanum boride. The ITO fine particles and the cesium tungstate fine particles have high visible light transmittance and have light absorbing property in a wide range of an infrared wavelength region exceeding 1,200 nm, and thus can be used in a case in which a shielding property of infrared light is required.

For example, when the filter is used in an imaging device such as a digital still camera, the filter can provide an imaging device having an excellent color reproducibility. The imaging device including the filter includes a solid state image sensor, an imaging lens, and the filter. The filter can be used, for example, by being disposed between the imaging lens and the solid state image sensor, or by being directly attached to the solid state image sensor, the imaging lens, or the like of the imaging device via an adhesive layer.

As described above, the present specification discloses the following optical filter and the like.
[1] An optical filter including:
a substrate; and
a dielectric multilayer film laid on or above at least one major surface of the substrate as an outermost layer, in which
the substrate includes a resin film containing a resin, a UV pigment 1 having a maximum absorption wavelength in 360 nm to 390 nm in the resin, and an IR pigment having a maximum absorption wavelength in 680 nm to 800 nm in the resin, the resin film having a thickness of 3 μm or less, and
the optical filter satisfies all of the following spectral characteristics (i-1) to (i-8):
(i-1) an average transmittance T_{360-400(0)AVE} in a spectral transmittance curve at a wavelength of 360 nm to 400 nm and an incident angle of 0 degrees is 0.5% or less,
(i-2) an average transmittance T_{350-390(50)AVE} in a spectral transmittance curve at a wavelength of 350 nm to 390 nm and an incident angle of 50 degrees is 0.5% or less,
(i-3) an average transmittance T_{400-430(0)AVE} in a spectral transmittance curve at a wavelength of 400 nm to 430 nm and an incident angle of 0 degrees is 35% or more,
(i-4) an average transmittance T_{430-500(0)AVE} in a spectral transmittance curve at a wavelength of 430 nm to 500 nm and an incident angle of 0 degrees is 88% or more,
(i-5) in a spectral transmittance curve at a wavelength of 350 nm to 450 nm and an incident angle of 0 degrees, a wavelength UV50₍₀₎ at which a transmittance is 50% is 400 nm to 430 nm,
(i-6) when an absolute value of a difference between a wavelength UV10₍₀₎ when a transmittance is 10% and a wavelength UV70₍₀₎ when the transmittance is 70% is ΔUV₇₀₋₁₀₍₀₎ in the spectral transmittance curve at the wavelength of 350 nm to 450 nm and the incident angle of 0 degrees, and an absolute value of a difference between a wavelength UV10₍₃₀₎ when a transmittance is 10% and a wavelength UV70₍₃₀₎ when the transmittance is 70% is ΔUV₇₀₋₁₀₍₃₀₎ in a spectral transmittance curve at a wavelength of 350 nm to 450 nm and an incident angle of 30 degrees,
an absolute value of a difference between ΔUV₇₀₋₁₀₍₀₎ and ΔUV₇₀₋₁₀₍₃₀₎ is 2.5 nm or less,
(i-7) in a spectral transmittance curve at a wavelength of 600 nm to 700 nm and an incident angle of 0 degrees, a wavelength IR50₍₀₎ at which a transmittance is 50% is 610 nm to 670 nm, and in a spectral transmittance curve at a wavelength of 600 nm to 700 nm and an incident angle of 30 degrees, a wavelength IR50₍₃₀₎ at which a transmittance is 50% is 610 nm to 670 nm, and
(i-8) an absolute value of a difference between the wavelength IR50₍₀₎ and the wavelength IR50₍₃₀₎ is 5 nm or less.
[2] The optical filter according to [1], in which
the optical filter further satisfies the following spectral characteristic (i-9):
(i-9) the absolute value of the difference between the wavelength UV10₍₀₎ and the wavelength UV70₍₀₎ is 13 nm or less.
[3] The optical filter according to [1] or [2], in which
a product of a content of the UV pigment 1 in the resin film and the thickness of the resin film is 15 (mass %·μm) or less.
[4] The optical filter according to any one of [1] to [3], in which
the resin film further contains a UV pigment 2 having a maximum absorption wavelength in 390 nm to 405 nm in the resin, the maximum absorption wavelength being larger than that of the UV pigment 1 by 10 nm or more, and
a product of a total content of the UV pigment 1 and the UV pigment 2 in the resin film and the thickness of the resin film is 15 (mass %·μm) or less.
[5] The optical filter according to any one of [1] to [4], in which
the UV pigment 1 satisfies all of the following spectral characteristics (ii-1) to (ii-3) in a spectral internal transmittance curve of a coating film obtained by dissolving the UV pigment 1 in the resin and coating an alkali glass plate with a mixture,
(ii-1) an absorbance at a maximum absorption wavelength is 0.1 (/mass %·μm) or more,
(ii-2) in the spectral internal transmittance curve of the coating film in which an internal transmittance at a maximum absorption wavelength is 1%, an average internal transmittance T_{350-400AVE} at a wavelength of 350 nm to 400 nm is 13% or less, and
(ii-3) in the spectral internal transmittance curve of the coating film normalized such that the internal transmittance at the maximum absorption wavelength is 1%, an absolute value of a difference between a wavelength UV10 when an internal transmittance at a wavelength of 350 nm to 450 nm is 10% and a wavelength UV70 when an internal transmittance is 70% is 10 nm or less.
[6] The optical filter according to any one of [1] to [5], in which
the UV pigment 1 is a cyanine compound represented by the following formula (S).

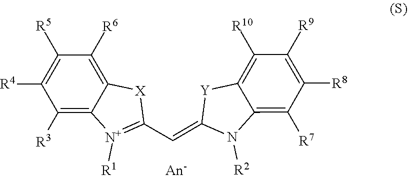

[Symbols in the above formula are as follows.
R¹ and R² each independently represent an alkyl group having 1 to 4 carbon atoms;
R³ to R¹⁰ each independently represent a hydrogen atom, a halogen atom, a sulfo group, a hydroxyl group, a cyano group, a nitro group, a carboxy group, a phenyl group, an alkyl group having 1 to 10 carbon atoms which may have a substituent, an alkoxy group having 1 to 10 carbon atoms which may have a substituent, an acyloxy group having 1 to 10 carbon atoms which may have a substituent, —NR¹¹R¹² (R¹¹ and R¹² are each independently a hydrogen atom, an alkyl group having 1 to 10 carbon atoms which may have a substituent, —C(═O)—R¹³ (R¹³ is an alkyl group having 1 to 10 carbon atoms or an aryl group having 6 to 11 carbon atoms, which may have a substituent), —SO₂—R¹⁴ (R¹⁴ is an alkyl group having 1 to 10 carbon atoms or an aryl group having 6 to 11 carbon atoms, which may have a substituent)), or —SO₂—R¹⁵ (R¹⁵ is an alkyl group having 1 to 10 carbon atoms or an aryl group having 6 to 11 carbon atoms, which may have a substituent, or —NR¹⁶R¹⁷ (R¹⁶ and R¹⁷ each independently represent a hydrogen atom or an alkyl group having 1 to 10 carbon atoms which may have a substituent));
X and Y each independently represent 0, S, or —C(CH₃)₂; and
An⁻ represents a monovalent anion.]
[7] The optical filter according to [6], in which
X and Y are O in the cyanine compound represented by the formula (S).
[8] The optical filter according to any one of [1] to [7], in which
the resin film satisfies all of the following spectral characteristics (iii-1) to (iii-9):
(iii-1) an internal transmittance T₃₆₀ at a wavelength of 360 nm is 25% or less,
(iii-2) an internal transmittance T₃₇₀ at a wavelength of 370 nm is 10% or less,
(iii-3) an internal transmittance T₃₈₀ at a wavelength of 380 nm is 4% or less,
(iii-4) an average internal transmittance T_{360-400AVE} in a spectral transmittance curve at a wavelength of 360 nm to 400 nm is 15% or less,
(iii-5) an average internal transmittance T_{400-430AVE} in a spectral transmittance curve at a wavelength of 400 nm to 430 nm is 40% or more,
(iii-6) an average internal transmittance T_{430-500AVE} in a spectral transmittance curve at a wavelength of 430 nm to 500 nm is 90% or more,
(iii-7) in a spectral transmittance curve at a wavelength of 350 nm to 450 nm, an absolute value of a difference between a wavelength UV10 when an internal transmittance is 10% and a wavelength UV70 when an internal transmittance is 70% is 17 nm or less,
(iii-8) an internal transmittance T₇₀₀ at a wavelength of 700 nm is 5% or less, and
(iii-9) in a spectral transmittance curve at a wavelength of 600 nm to 700 nm, a wavelength IR50 at which an internal transmittance is 50% is 610 nm to 670 nm.
[9] The optical filter according to [4], in which
the UV pigment 2 contains a merocyanine compound.
[10] The optical filter according to any one of [1] to [9], in which
the IR pigment contains at least one compound selected from the group consisting of a squarylium compound, a phthalocyanine compound, and a cyanine compound.
[11] The optical filter according to any one of [1] to [10], in which
the resin is a transparent resin.
[12] The optical filter according to [11], further including:
a polyimide resin as the transparent resin.
[13] An imaging device including:
the optical filter according to any one of [1] to [12].

### EXAMPLES

Next, the present invention will be described more specifically with reference to examples.

For measurement of each optical characteristic, an ultraviolet-visible-near-infrared spectrophotometer (UH-4150 type, manufactured by Hitachi High-Tech Corporation) was used.

The spectral characteristic in a case in which an incident angle is not particularly specified is a value measured at an incident angle of 0 degrees (in a direction perpendicular to a major surface).

Pigments used in respective examples are as follows.

Compounds 1 to 18 are UV pigments, and a compound 19 is an NIR pigment.

Compounds 1 to 4 (cyanine compounds): synthesized by a method to be described later with reference to JP2011-102841A and JP47027311B.

Compound 5 (azo compound): synthesized with reference to JP6256335B.

Compound 6 (triazine compound): Tinuvin 928 manufactured by BASF Japan Ltd.

Compound 7: Tinuvin 460 manufactured by BASF Japan Ltd.

Compounds 8 to 12 (merocyanine compounds): synthesized with reference to JP6504176B.

Compound 13: Nikkafluor U1 manufactured by Nippon Chemical Industrial Co., Ltd.

Compound 14: Nikkafluor MCT manufactured by Nippon Chemical Industrial Co., Ltd.

Compound 15 (cyanine compound): SMP-416 manufactured by Hayashibara Chemical Co., Ltd.

Compound 16 (cyanine compound): SMP-370 manufactured by Hayashibara Chemical Co., Ltd.

Compound 17: Kayalight B manufactured by Nippon Kayaku Co., Ltd.

Compound 18: Kayalight 408 manufactured by Nippon Kayaku Co., Ltd.

Compound 19 (squarylium compound): synthesized with reference to JP6197940B.

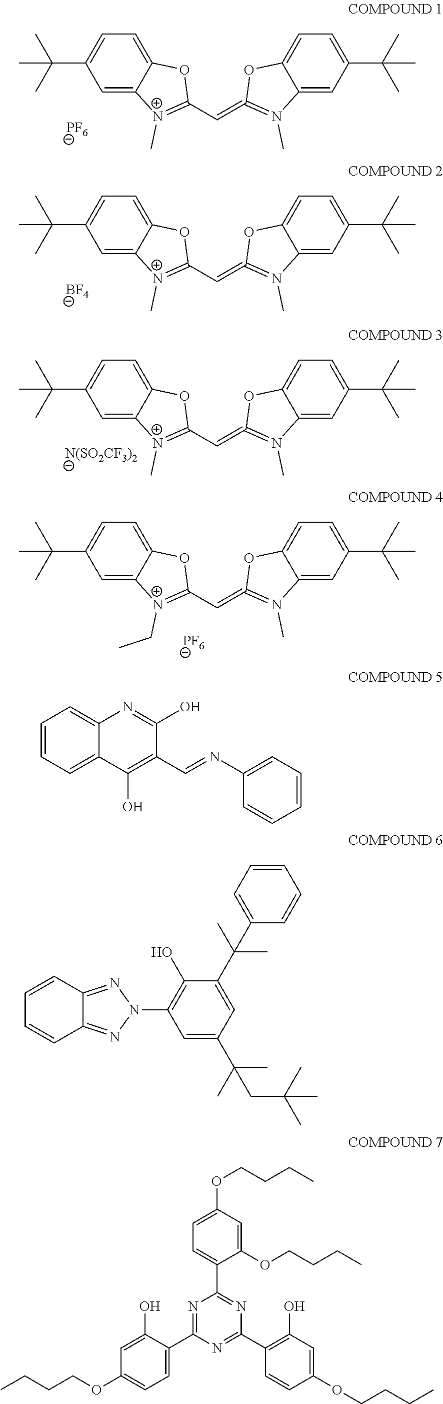

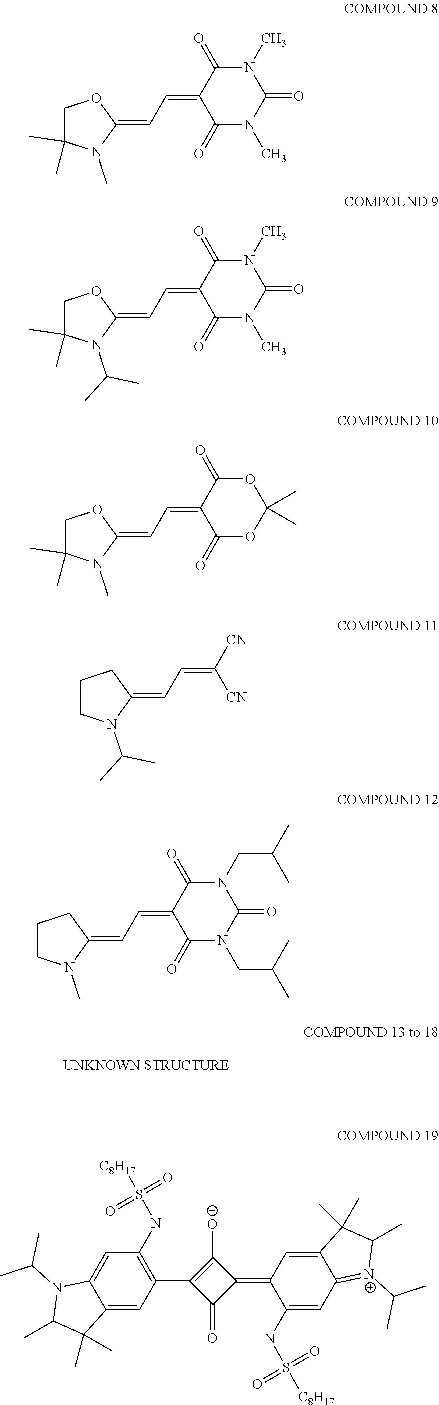

### <Synthesis of Compound 1>

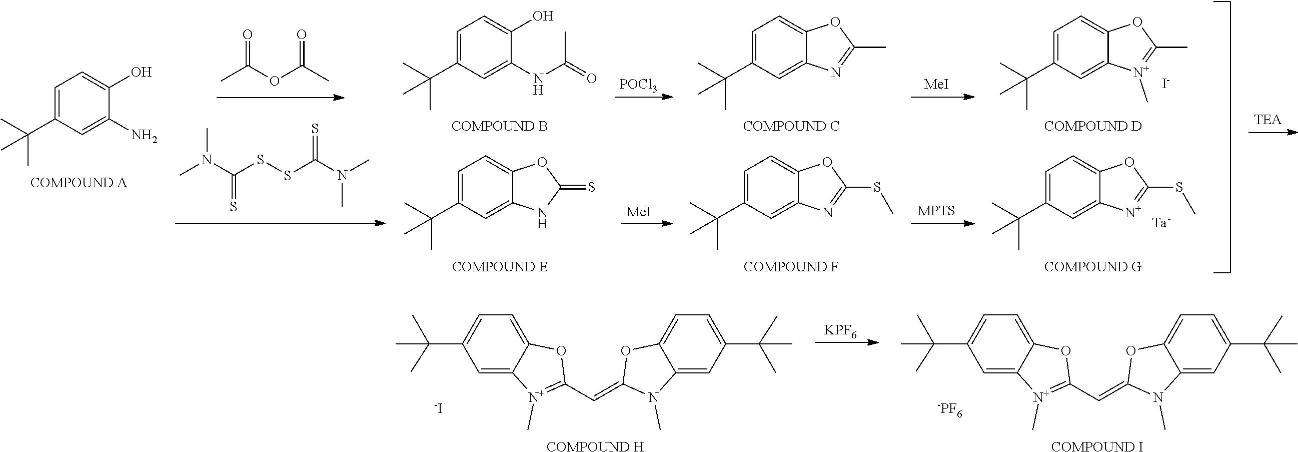

### (Synthesis of Compound B)

A compound A (5.0 g), acetic anhydride (3.4 g), and ethyl acetate (60 mL) were added to a 500 mL eggplant flask, and a mixture was reacted at room temperature for 2 hours. After completion of the reaction, a precipitated solid was collected by filtration to obtain 5.5 g (88%) of a compound B.

### (Synthesis of Compound C)

The compound B (5.0 g), phosphoryl chloride (5.6 g), and chloroform (13 mL) were added to a 300 mL eggplant flask, and a mixture was reacted for 2 hours under reflux. After the completion of the reaction, the mixture was returned to room temperature environment, and a reaction solution was poured into ice water to stop the reaction. After extraction, purification was performed by column chromatography to obtain 2.5 g (53%) of a compound C.

### (Synthesis of Compound D)

The compound C (2.5 g), iodomethane (7.4 g), and DMF (15 mL) were added to a 300 mL eggplant flask, and a mixture was reacted at 80 degrees for 2 hours. After the completion of the reaction, the mixture was returned to room temperature environment, ethyl acetate was added, and a precipitated solid was collected by filtration to obtain 2.9 g (77%) of a compound D.

### (Synthesis of Compound E)

The compound A (28 g), tetramethylthiuram disulfide (24 g), potassium carbonate (69 g), and DMF (500 mL) were added to a 1 L eggplant flask, and a mixture was reacted for 15 hours under reflux. After the completion of the reaction, the mixture was returned to room temperature environment, and an aqueous ammonium chloride solution was added to stop the reaction. After extraction, purification was performed by column chromatography to obtain 25 g (71%) of a compound E.

### (Synthesis of Compound F)

The compound E (25 g), iodomethane (17 g), potassium carbonate (40 g), and ethyl acetate (100 mL) were added to a 1 L eggplant flask, and a mixture was reacted at room temperature for 3 hours. After the completion of the reaction, water was added to stop the reaction. After extraction, a solvent was removed to obtain 28 g (quant.) of a compound F.

### (Synthesis of Compound G)

The compound F (28 g) and methyl p-toluenesulfonate (45 g) were added to a 1 L eggplant flask, and a mixture was reacted at 130 degrees for 2 hours. After the completion of the reaction, the mixture was returned to room temperature environment, THF was added, and a precipitated solid was collected by filtration to obtain 34 g (70%) of a compound G.

### (Synthesis of Compound H)

The compound D (15 g), the compound G (19 g), triethylamine (6.9 g), and acetonitrile (90 mL) were added to a 500 mL eggplant flask, and a mixture was reacted for 2 hours under reflux. After the completion of the reaction, the mixture was returned to room temperature environment and a precipitated solid was collected by filtration to obtain 15 g (62%) of a compound H.

### (Synthesis of Compound 1)

The compound H (3.0 g), potassium hexafluorophosphate (2.1 g), acetone (25 mL), methanol (25 mL), and water (25 mL) were added to a 300 mL eggplant flask, and a mixture was reacted at room temperature for 3 hours. After the completion of the reaction, purification was performed by column chromatography to obtain 2.7 g (86%) of the compound 1.

### <Synthesis of Compound 2>

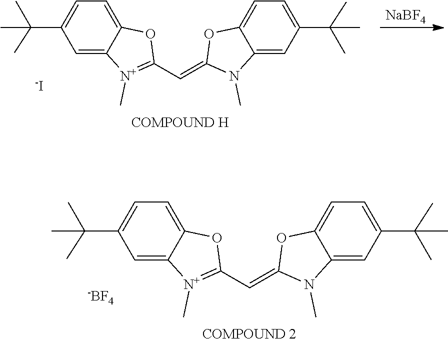

The compound H (3.0 g), sodium tetrafluoroborate (2.0 g), acetone (25 mL), methanol (25 mL), and water (25 mL) were added to a 300 mL eggplant flask, and a mixture was reacted at room temperature for 3 hours. After completion of the reaction, purification was performed by column chromatography to obtain 2.0 g (72%) of the compound 2.

### <Synthesis of Compound 3>

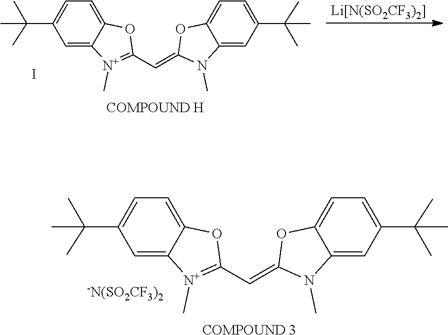

The compound H (3.0 g), bis(trifluoromethane sulfonyl)imide lithium (3.3 g), acetone (25 mL), methanol (25 mL), and water (25 mL) were added to a 300 mL eggplant flask, and a mixture was reacted at room temperature for 3 hours. After completion of the reaction, purification was performed by column chromatography to obtain 3.6 g (92%) of the compound 3.

### <Synthesis of Compound 4>

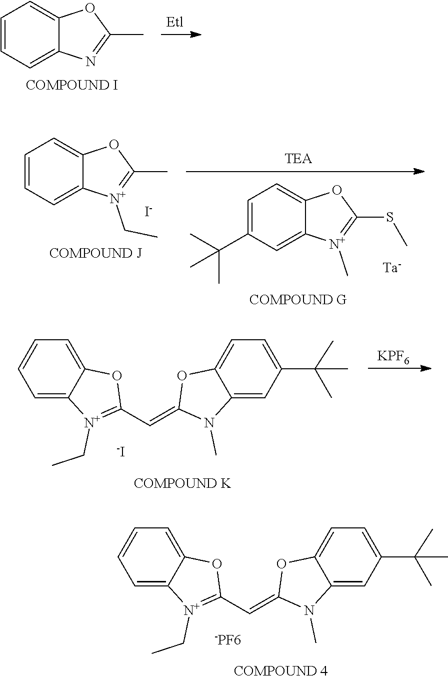

### (Synthesis of Compound J)

A compound I (12 g), iodoethane (56 g), and DMF (45 mL) were added to a 300 mL eggplant flask, and a mixture was reacted at 90 degrees for 15 hours. After completion of the reaction, ethyl acetate was added, and a precipitated solid was collected by filtration to obtain 24 g (91%) of a compound J.

### (Synthesis of Compound K)

The compound J (7.1 g), the compound G (10 g), triethylamine (3.7 g), and acetonitrile (50 mL) were added to a 500 mL eggplant flask, and a mixture was reacted for 2 hours under reflux. After completion of the reaction, purification was performed by column chromatography to obtain 10 g (87%) of a compound K.

### (Synthesis of Compound 4)

The compound K (3.0 g), potassium hexafluorophosphate (2.3 g), acetone (25 mL), methanol (25 mL), and water (25 mL) were added to a 300 mL eggplant flask, and a mixture was reacted at room temperature for 3 hours. After completion of the reaction, purification was performed by column chromatography to obtain 1.5 g (48%) of the compound 4.

### Spectral Characteristics of Pigment in Resin (in Coating Film)

### Example 1-1

A polyimide resin (C-3G30G manufactured by Mitsubishi Gas Chemical Company) was dissolved in an organic solvent (cyclohexanone:γ-butyrolactone=1:1 mass ratio) at a concentration of 8.5 mass %.

The compound 1 was added to the polyimide resin solution prepared above in an amount of 7.5 parts by mass based on 100 parts by mass of the resin, and a mixture was stirred for 2 hours while being heated to 50° C. The pigment-containing resin solution was spin-coated onto a glass substrate (alkali glass, D263 manufactured by schott) to obtain a coating film having a film thickness of 1 μm.

### Examples 1-2 to 1-18

Coating films were prepared in the same manner as in Example 1-1 except that the compounds 2 to 18 were used instead of the compound 1.

However, only the compound 5 was added in an amount of 4 parts by mass based on 100 parts by mass of the resin.

Transmission spectroscopy (incident angle of 0 degrees) and reflection spectroscopy (incident angle of 5 degrees) in a wavelength range of 350 nm to 1,200 nm were measured for each of the obtained coating-film-equipped glass substrates using the spectrophotometer. A spectral internal transmittance curve was calculated using the obtained spectral transmittance curve and the obtained spectral reflectance curve, and an absorbance at a maximum absorption wavelength when an amount of adding the pigment was 1 oas and a spectral transmittance curve normalized such that an internal transmittance at the maximum absorption wavelength was 100 were obtained.

Results are shown in the following table.

Examples 1-1 to 1-18 are reference examples.

TABLE 3

| | | Maximum | | | |
|---|---|---|---|---|---|
| | | absorption | | Average internal | |
| | | wavelength | Absorbance | transmittanceT350- | |
| | UV pigment | in resin | in resin | 400AVE | \|UV10-UV70\| |
| | compound | (nm) | (/mass % · μm) | (%) | (nm) |
| Example 1-1 | 1 | 372 | 0.124 | 7.2 | 8.7 |
| Example 1-2 | 2 | 372 | 0.138 | 7.1 | 9.4 |
| Example 1-3 | 3 | 385 | 0.103 | 7.6 | 9.2 |
| Example 1-4 | 4 | 383 | 0.125 | 10.1 | 9.3 |
| Example 1-5 | 5 | 382 | 0.096 | 2.2 | 14.7 |
| Example 1-6 | 6 | 350 | 0.032 | 27.3 | 20.1 |
| Example 1-7 | 7 | 351 | 0.083 | 37.2 | 17.9 |
| Example 1-8 | 8 | 397 | 0.242 | 24.1 | 11.1 |
| Example 1-9 | 9 | 399 | 0.242 | 27.2 | 11.1 |
| Example 1-10 | 10 | 379 | 0.206 | 12.0 | 11.1 |
| Example 1-11 | 11 | 391 | 0.055 | 8.9 | 11.2 |
| Example 1-12 | 12 | 414 | 0.210 | 48.8 | 11.8 |
| Example 1-13 | 13 | 406 | 0.131 | 21.9 | 11.8 |
| Example 1-14 | 14 | 406 | 0.159 | 20.2 | 11.9 |
| Example 1-15 | 15 | 362 | 0.051 | 6.1 | 21.1 |
| Example 1-16 | 16 | 376 | 0.089 | 3.5 | 16.6 |
| Example 1-17 | 17 | 376 | 0.089 | 3.6 | 16.7 |
| Example 1-18 | 18 | 366 | 0.089 | 2.3 | 16.0 |

From the above results, it can be seen that the coating films in Examples 1-1 to 1-4 containing any one of the compounds 1 to 4 as the UV pigment have a high absorption ability since the maximum absorption wavelength of the pigment is 360 nm to 390 nm and the absorbance is 0.1 or more, have an excellent light shielding property in a near ultraviolet region since the average internal transmittance T_{350-400AVE} is 13% or less, and have a steep rise (slope) in a transmittance curve from the near ultraviolet region to the visible light region, that is, a high transmittance in the blue color band, since the absolute value of the difference between the wavelength UV10 when the internal transmittance is 10% and the wavelength UV70 when the internal transmittance is 70% is 10 nm or less.

### Spectral Characteristics of Resin Film

### Example 2-1

A polyimide resin (C-3G30G manufactured by Mitsubishi Gas Chemical Company) was dissolved in an organic solvent (cyclohexanone:γ-butyrolactone=1:1 mass ratio) at a concentration of 8.5 mass %.

To the solution of the polyimide resin prepared above, the compound 1 was added in an amount of 9 parts by mass and the compound 19 was added in an amount of 5 parts by mass based on 100 parts by mass of the resin, and a mixture was stirred for 2 hours while being heated to 50° C. The pigment-containing resin solution was spin-coated onto a glass substrate (alkali glass, D263 manufactured by schott) to obtain a resin film having a film thickness of 1.5 m.

### Examples 2-2 to 2-23

Resin films were obtained in the same manner as in Example 2-1, except that pigment compounds were respectively used in concentrations shown in the following table in place of the compound 1, and film thicknesses of the resin films were respectively set to values shown in the following table.

Transmission spectroscopy (incident angle of 0 degrees) and reflection spectroscopy (incident angle of 5 degrees) in a wavelength range of 350 nm to 1,200 nm were measured for each of the obtained resin-film-equipped glass substrates using the spectrophotometer. A spectral internal transmittance curve was calculated using an obtained spectral transmittance curve and an obtained spectral reflectance curve.

Results are shown in the following table.

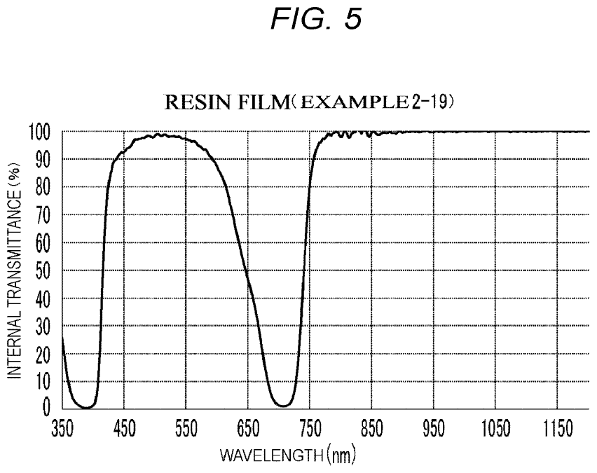

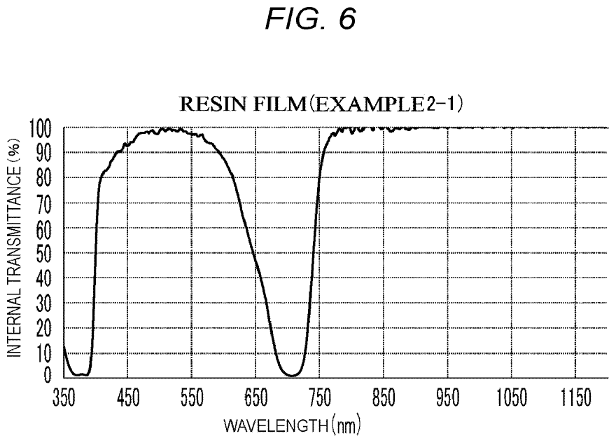

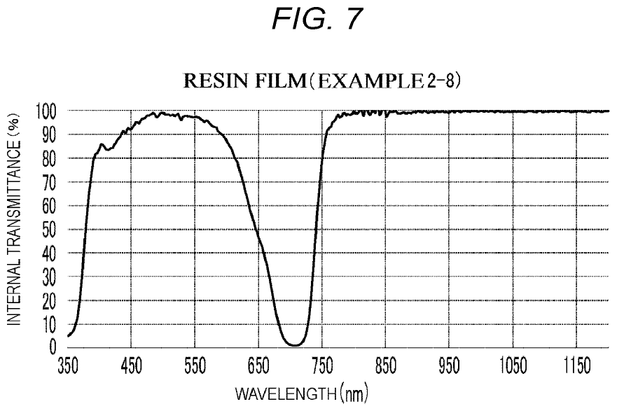

Further, a spectral internal transmittance curve of the resin film in Example 2-19 is shown in FIG. 5, a spectral internal transmittance curve of the resin film in Example 2-1 is shown in FIG. 6, and a spectral internal transmittance curve of the resin film in Example 2-8 is shown in FIG. 7.

Examples 2-1 to 2-23 are reference examples.

TABLE 4

| | | Exam- | Exam- | Exam- | Exam- | Exam- | Exam- | Exam- | Exam- | Exam- | Exam- | Exam- | Exam- |
|---|---|---|---|---|---|---|---|---|---|---|---|---|---|
| | | ple 2-1 | ple 2-2 | ple 2-3 | ple 2-4 | ple 2-5 | ple 2-6 | ple 2-7 | ple 2-8 | ple 2-9 | ple 2-10 | ple 2-11 | ple 2-12 |
| UV pigment | Compound | 1 | 1 | 2 | 3 | 4 | 5 | 6 | 7 | 8 | 9 | 11 | 12 |
| 1 | Content (mass %) | 9 | 12 | 9 | 7.5 | 9 | 4 | 7.5 | 7.5 | 7.5 | 7.5 | 7.5 | 7.5 |
| UV pigment | Compound | — | — | — | — | — | — | — | — | — | — | — | — |
| 2 | Content (mass %) | — | — | — | — | — | — | — | — | — | — | — | — |
| Resin film thickness (μm) | | 1.5 | 1.5 | 1.5 | 2 | 1.5 | 2.5 | 2 | 2 | 1.5 | 1.5 | 1.5 | 1.5 |
| (Content of UV pigment 1 \| UV | | 13.5 | 18 | 13.5 | 15 | 13.5 | 10 | 15 | 15 | 11.3 | 11.3 | 11.3 | 11.3 |
| pigment 2) * film thickness | | | | | | | | | | | | | |
| (mass % · μm) | | | | | | | | | | | | | |
| IR pigment | Compound | 19 | 19 | 19 | 19 | 19 | 19 | 19 | 19 | 19 | 19 | 19 | 19 |
| | Content (mass %) | 5 | 5 | 5 | 3.75 | 5 | 3 | 3.75 | 3.75 | 5 | 5 | 5 | 5 |
| Spectral | T360 (%) | 5.1 | 1.9 | 4.1 | 8.0 | 4.2 | 14.0 | 33.8 | 7.9 | 37.0 | 42.4 | 53.2 | 73.3 |
| characteristic | T370 (%) | 2.0 | 0.6 | 1.3 | 3.2 | 2.0 | 10.9 | 46.3 | 22.1 | 12.3 | 16.6 | 36.9 | 52.8 |
| of resin film | T380 (%) | 2.3 | 0.7 | 1.7 | 3.5 | 2.0 | 9.9 | 63.7 | 55.0 | 2.0 | 3.0 | 27.1 | 28.0 |
| | T360-400AVE (%) | 8.3 | 5.2 | 6.9 | 10.6 | 11.8 | 12.8 | 62.2 | 50.0 | 8.0 | 10.1 | 31.3 | 31.6 |
| | T400-430AVE (%) | 80.6 | 79.0 | 80.0 | 81.2 | 83.3 | 58.2 | 85.1 | 84.9 | 36.9 | 31.3 | 70.4 | 3.3 |
| | T430-500AVE (%) | 95.2 | 95.2 | 95.3 | 94.9 | 95.2 | 95.0 | 95.4 | 95.0 | 94.5 | 95.0 | 95.4 | 88.1 |
| | \|UV10 − UV70\| | 10.2 | 9.6 | 10.0 | 10.5 | 10.2 | 34.2 | No | 23.2 | 10.5 | 11.3 | No | 11.4 |
| | (nm) | | | | | | | UV10 | | | | UV10 | |
| | T700 (%) | 1.3 | 1.3 | 1.3 | 1.3 | 1.3 | 1.3 | 1.3 | 1.3 | 1.3 | 1.3 | 1.3 | 1.3 |
| | IR50 (nm) | 646.2 | 646.2 | 646.2 | 646.1 | 646.5 | 646.0 | 646.3 | 645.6 | 646.0 | 646.2 | 646.2 | 646.3 |

| | | Exam- | Exam- | Exam- | Exam- | Exam- | Exam- | Exam- | Exam- | Exam- | Exam- | Exam- |
|---|---|---|---|---|---|---|---|---|---|---|---|---|
| | | ple 2-13 | ple 2-14 | ple 2-15 | ple 2-16 | ple 2-17 | ple 2-18 | ple 2-19 | ple 2-20 | ple 2-21 | ple 2-22 | ple 2-23 |
| UV pigment | Compound | 13 | 14 | 15 | 16 | 17 | 18 | 1 | 4 | 1 | 1 | 10 |
| 1 | Content (mass %) | 7.5 | 7.5 | 7.5 | 7.5 | 7.5 | 7.5 | 5 | 4 | 7 | 6 | 7.5 |
| UV pigment | Compound | — | — | — | — | — | — | 8 | 8 | 8 | 8 | — |
| 2 | Content (mass %) | — | — | — | — | — | — | 5 | 5 | 5 | 2 | — |
| Resin film thickness (μm) | | 1.5 | 1.5 | 2 | 2 | 2 | 2 | 1.5 | 1.5 | 1.5 | 4 | 1.5 |
| (Content of UV pigment 1 \| UV | | 11.3 | 11.3 | 15 | 15 | 15 | 15 | 15 | 13.5 | 18 | 32 | 11.3 |
| pigment 2) * film thickness | | | | | | | | | | | | |
| (mass % · μm) | | | | | | | | | | | | |
| IR pigment | Compound | 19 | 19 | 19 | 19 | 19 | 19 | 19 | 19 | 19 | 19 | 19 |
| | Content (mass %) | 5 | 5 | 3.75 | 3.75 | 3.75 | 3.75 | 5 | 5 | 5 | 1.9 | 5 |
| Spectral | T360 (%) | 50.6 | 41.0 | 16.2 | 6.1 | 6.2 | 4.6 | 10.0 | 12.7 | 3.8 | 0.3 | 5.0 |
| characteristic | T370 (%) | 28.8 | 20.1 | 18.0 | 4.3 | 4.5 | 4.3 | 2.9 | 4.4 | 0.8 | 0.0 | 1.0 |
| of resin film | T380 (%) | 12.1 | 6.9 | 24.3 | 4.5 | 4.7 | 4.8 | 0.9 | 1.3 | 0.3 | 0.0 | 0.4 |
| | T360-400AVE (%) | 18.4 | 12.6 | 28.6 | 8.4 | 8.6 | 7.1 | 2.2 | 3.2 | 0.8 | 0.1 | 7.2 |
| | T400-430AVE (%) | 28.1 | 24.0 | 76.6 | 67.8 | 68.1 | 53.8 | 42.5 | 42.8 | 42.4 | 41.0 | 79.3 |
| | T430-500AVE (%) | 94.1 | 93.7 | 95.2 | 95.1 | 95.2 | 95.3 | 94.7 | 94.7 | 94.6 | 94.2 | 95.1 |
| | \|UV10 − UV70\| | 13.4 | 13.1 | No | 22.1 | 22.3 | 27.8 | 12.6 | 12.6 | 12.6 | 12.4 | 12.6 |
| | (nm) | | | UV10 | | | | | | | | |
| | T700 (%) | 1.3 | 1.3 | 1.3 | 1.3 | 1.3 | 1.3 | 1.3 | 1.3 | 1.3 | 1.3 | 1.3 |
| | IR50 (nm) | 646.4 | 646.2 | 646.2 | 646.2 | 646.2 | 646.3 | 646.0 | 647.2 | 646.0 | 646.0 | 646.3 |

From the above results, the resin films in Examples 2-1 to 2-5 and Examples 2-19 to 2-23 showed excellent spectral characteristics in the near ultraviolet region. Among them, Examples 2-19 to 2-22, in which two types of UV pigments having different maximum wavelength regions are used together, achieved a wide range of absorption. However, in each of the resin films in Example 2-2 and Example 2-21, an amount of adding the UV pigment was large, and the resin film in Example 2-22 had a large film thickness, and thus a product of a UV pigment content and the thickness of the resin film was large.

The resin films in Examples 2-7 to 2-14 contained only a UV pigment in which a region of the maximum absorption wavelength deviates from the range of 360 nm to 390 nm, and thus a shielding property in the near-ultraviolet light region of 360 nm to 400 nm and transparency in a blue light region of 400 nm to 430 nm were low.

The resin films in Examples 2-6 and 2-15 to 2-18 contained the UV pigment having a low absorbance in the resin, that is, a weak absorption, and thus a shielding property in the near-ultraviolet light region of 360 nm to 400 nm was low.

### Spectral Characteristics of Optical Filter

### Example 3-1

A dielectric multilayer film (reflection film) in which 42 layers of SiO₂ and TiO₂ were alternately laid on or above one major surface of a glass substrate (alkali glass, D263 manufactured by schott) was formed by vacuum evaporation. The spectral characteristics are shown in the following table. A resin film was prepared on the other surface of the glass substrate in the same manner as in Example 2-1 using pigment compounds in contents shown in the following table. Thereafter, a dielectric multilayer film (antireflection film) in which SiO₂ and TiO₂ were alternately laid was formed on the resin film, and an optical filter was prepared.

### Examples 3-2 to 3-21

Optical filters were prepared in the same manner as in Example 3-1, except that a type and a content of the pigment compound and the thickness of the resin film were changed to values shown in the following table.

For each of the obtained optical filters, transmission spectroscopy (incident angles: 0 degrees, 30 degrees, 50 degrees) in a wavelength range of 350 nm to 1,200 nm was measured using the spectrophotometer, and each spectral characteristic was calculated.

Results are shown in the following table.

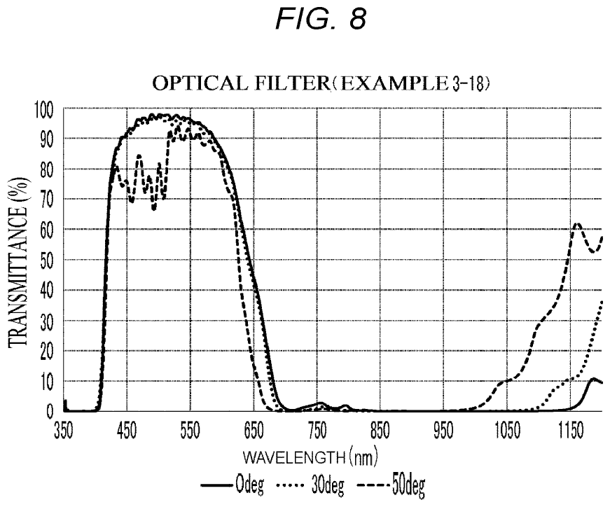

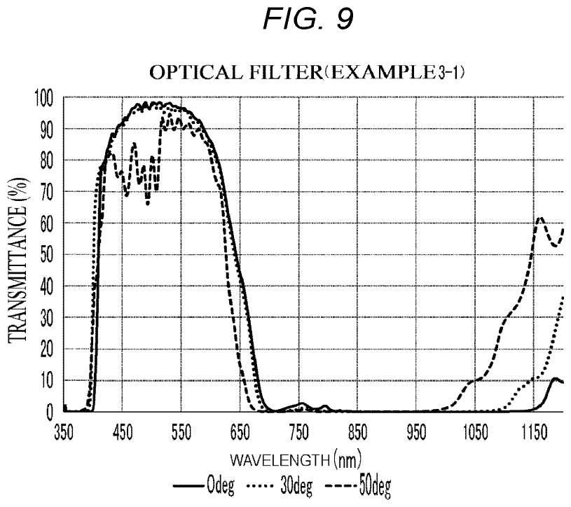

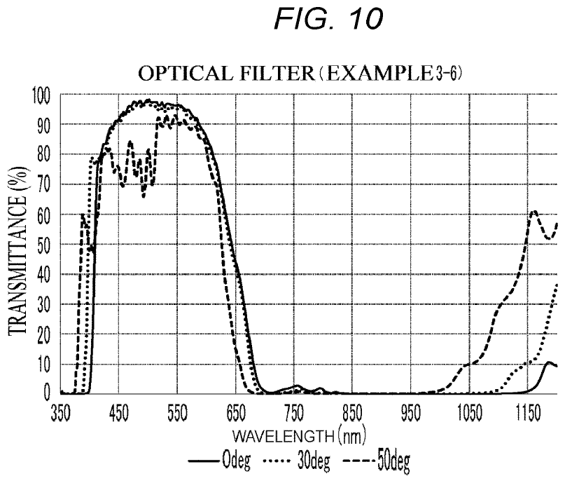

Further, a spectral transmittance curve of the optical filter in Example 3-18 is shown in FIG. 8, a spectral transmittance curve of the optical filter in Example 3-1 is shown in FIG. 9, and a spectral transmittance curve of the optical filter in Example 3-6 is shown in FIG. 10.

Examples 3-1 to 3-3 and Examples 3-18 to 3-20 are inventive examples. Examples 3-4 to 3-17 and Example 3-21 are comparative examples.

TABLE 5

| | | |
|---|---|---|
| Spectral characteristic | Average transmittance at 360 nm to | 0.4 |
| of dielectric | 400 nm (%) | |
| multilayer film | Average transmittance at 430 nm to | 95.0 |
| (incident angle: 0°) | 500 nm (%) | |
| | Average transmittance at 750 nm to | 0.5 |
| | 1000 nm (%) | |
| | UV50 (nm) | 408.1 |
| | TR50 (nm) | 710.1 |

TABLE 6

| | | Example | Example | Example | Example | Example |
|---|---|---|---|---|---|---|
| | | 3-1 | 3-2 | 3-3 | 3-4 | 3-5 |
| Resin film | Type | Example | Example | Example | Example | Example |
| composition | | 2-1 | 2-2 | 2-5 | 2-6 | 2-7 |
| | UV pigment 1 compound | 1 | 1 | 4 | 5 | 6 |
| | Content of UV pigment 1 (mass %) | 9 | 12 | 9 | 4 | 7.5 |
| | UV pigment 2 compound | — | — | — | — | — |
| | Content of UV pigment 2 (mass %) | — | — | — | — | — |
| | Content of IR pigment (mass %) | 5 | 5 | 5 | 3 | 3.75 |
| | Film thickness (μm) | 1.5 | 1.5 | 1.5 | 2.5 | 2 |
| | Content of UV pigment 1 + UV pigment | 13.5 | 18 | 13.5 | 10 | 15 |
| | 2 * film thickness (mass % · μm) | | | | | |
| Spectral | T360-400(0)AVE (%) | 0.0 | 0.0 | 0.1 | 0.0 | 0.2 |
| characteristic | T360-400(0)MAX (%) | 0.9 | 0.8 | 1.2 | 0.4 | 1.5 |
| of optical | T350-390(50)AVE (%) | 0.3 | 0.1 | 0.5 | 1.6 | 13.1 |
| filter | T350-390(50)MAX (%) | 2.0 | 0.6 | 4.9 | 8.0 | 61.5 |
| | T400-430(0)AVE (%) | 58.5 | 58.1 | 59.3 | 47.7 | 59.4 |
| | T430-500(0)AVE (%) | 94.1 | 93.9 | 93.9 | 93.8 | 94.2 |
| | UV50(0) (nm) | 409.5 | 409.5 | 409.3 | 413.0 | 409.2 |
| | \|UV10(0) − UV70(0)\| (nm) | 8.5 | 8.4 | 8.6 | 12.7 | 8.7 |
| | \|UV10(30) − UV70(30)\| (nm) | 9.6 | 9.8 | 7.8 | 23.4 | 8.8 |
| | \|ΔUV70-10(0) − UV70-10(30)\| (nm) | 1.0 | 1.5 | 0.7 | 10.6 | 0.1 |
| | IR50(0) (nm) | 643.2 | 643.2 | 643.0 | 642.8 | 642.7 |
| | IR50(30) (nm) | 640.2 | 640.2 | 640.0 | 639.6 | 639.9 |
| | \|IR50(0) − IR50(30)\| (nm) | 3.0 | 3.0 | 3.0 | 3.2 | 2.9 |
| | | Example | Example | Example | Example | Example |
| | | 3-6 | 3-7 | 3-8 | 3-9 | 3-10 |
| Resin film | Type | Example | Example | Example | Example | Example |
| composition | | 2-8 | 2-9 | 2-10 | 2-23 | 2-11 |
| | UV pigment 1 compound | 7 | 8 | 9 | 10 | 11 |
| | Content of UV pigment 1 (mass %) | 7.5 | 7.5 | 7.5 | 7.5 | 7.5 |
| | UV pigment 2 compound | — | — | — | — | — |
| | Content of UV pigment 2 (mass %) | — | — | — | — | — |
| | Content of IR pigment (mass %) | 3.75 | 5 | 5 | 5 | 5 |
| | Film thickness (μm) | 2 | 1.5 | 1.5 | 1.5 | 1.5 |
| | Content of UV pigment 1 + UV pigment | 15 | 11.3 | 11.3 | 11.3 | 11.3 |
| | 2 * film thickness (mass % · μm) | | | | | |
| Spectral | T360-400(0)AVE (%) | 0.1 | 0.0 | 0.0 | 0.0 | 0.1 |
| characteristic | T360-400(0)MAX (%) | 1.5 | 0.1 | 0.2 | 0.8 | 0.5 |
| of optical | T350-390(50)AVE (%) | 12.2 | 0.3 | 0.4 | 0.2 | 3.5 |
| filter | T350-390(50)MAX (%) | 60.0 | 2.2 | 2.5 | 1.6 | 13.2 |
| | T400-430(0)AVE (%) | 59.2 | 34.1 | 29.2 | 58.1 | 54.5 |
| | T430-500(0)AVE (%) | 93.9 | 93.3 | 93.9 | 94.0 | 94.2 |
| | UV50(0) (nm) | 409.2 | 418.7 | 420.7 | 409.6 | 410.7 |
| | \|UV10(0) − UV70(0)\| (nm) | 8.9 | 11.5 | 11.8 | 8.4 | 8.4 |
| | \|UV10(30) − UV70(30)\| (nm) | 8.9 | 12.5 | 12.4 | 11.5 | 16.5 |
| | \|ΔUV70-10(0) − UV70-10(30)\| (nm) | 0.0 | 1.0 | 0.6 | 3.2 | 8.1 |
| | IR50(0) (nm) | 643.0 | 642.9 | 643.3 | 644.0 | 643.1 |
| | IR50(30) (nm) | 640.0 | 639.8 | 640.1 | 641.0 | 640.1 |
| | \|IR50(0) − IR50(30)\| (nm) | 3.1 | 3.1 | 3.2 | 3.1 | 3.1 |

| | | Example | Example | Example | Example | Example | Example |
|---|---|---|---|---|---|---|---|
| | | 3-11 | 3-12 | 3-13 | 3-14 | 3-15 | 3-16 |
| Resin film | Type | Example | Example | Example | Example | Example | Example |
| composition | | 2-12 | 2-13 | 2-14 | 2-15 | 2-16 | 2-17 |
| | UV pigment 1 compound | 12 | 13 | 14 | 15 | 16 | 17 |
| | Content of UV pigment 1 (mass %) | 7.5 | 7.5 | 7.5 | 7.5 | 7.5 | 7.5 |
| | UV pigment 2 compound | — | — | — | — | — | — |
| | Content of UV pigment 2 (mass %) | — | — | — | — | — | — |
| | Content of IR pigment (mass %) | 5 | 5 | 5 | 3.75 | 3.75 | 3.75 |
| | Film thickness (μm) | 1.5 | 1.5 | 1.5 | 2 | 2 | 2 |
| | Content of UV pigment 1 + UV pigment | 11.3 | 11.3 | 11.3 | 15 | 15 | 15 |
| | 2 * film thickness (mass % · μm) | | | | | | |
| Spectral | T360-400(0)AVE (%) | 0.1 | 0.0 | 0.0 | 0.1 | 0.0 | 0.0 |
| characteristic | T360-400(0)MAX (%) | 0.7 | 0.3 | 0.2 | 1.0 | 0.5 | 0.5 |
| of optical | T350-390(50)AVE (%) | 2.9 | 1.2 | 0.7 | 4.7 | 0.7 | 0.8 |
| filter | T350-390(50)MAX (%) | 9.7 | 3.2 | 2.4 | 23.9 | 4.4 | 4.6 |
| | T400-430(0)AVE (%) | 2.7 | 25.1 | 21.8 | 56.1 | 52.7 | 53.0 |
| | T430-500(0)AVE (%) | 87.0 | 92.9 | 92.5 | 94.1 | 94.0 | 94.1 |
| | UV50(0) (nm) | 434.8 | 422.6 | 423.8 | 410.1 | 411.1 | 411.0 |
| | \|UV10(0) − UV70(0)\| (nm) | 11.6 | 14.1 | 13.8 | 9.2 | 10.6 | 10.7 |
| | \|UV10(30) − UV70(30)\| (nm) | 11.5 | 14.7 | 14.1 | 16.8 | 18.5 | 18.7 |
| | \|ΔUV70-10(0) − UV70-10(30)\| (nm) | 0.1 | 0.6 | 0.3 | 7.6 | 7.9 | 8.0 |
| | IR50(0) (nm) | 643.3 | 643.2 | 643.2 | 643.2 | 643.2 | 643.3 |
| | IR50(30) (nm) | 640.1 | 640.0 | 640.0 | 640.2 | 640.1 | 640.1 |
| | IR50(0) − IR50(30)\| (nm) | 3.2 | 3.2 | 3.2 | 3.0 | 3.1 | 3.2 |

| | | Example | Example | Example | Example | Example |
|---|---|---|---|---|---|---|
| | | 3-17 | 3-18 | 3-19 | 3-20 | 3-21 |
| Resin film | Type | Example | Example | Example | Example | Example |
| composition | | 2-18 | 2-19 | 2-20 | 2-21 | 2-22 |
| | UV pigment 1 compound | 18 | 1 | 4 | 1 | 1 |
| | Content of UV pigment 1 (mass %) | 7.5 | 5 | 4 | 7 | 6 |
| | UV pigment 2 compound | — | 8 | 8 | 8 | 8 |
| | Content of UV pigment 2 (mass %) | — | 5 | 5 | 5 | 2 |
| | Content of IR pigment (mass %) | 3.75 | 5 | 5 | 5 | 1.9 |
| | Film thickness (μm) | 2 | 1.5 | 1.5 | 1.5 | 4 |
| | Content of UV pigment 1 + UV pigment | 15 | 15 | 13.5 | 18 | 32 |
| | 2 * film thickness (mass % · μm) | | | | | |
| Spectral | T360-400(0)AVE (%) | 0.0 | 0.0 | 0.0 | 0.0 | 0.0 |
| characteristic | T360-400(0)MAX (%) | 0.2 | 0.0 | 0.0 | 0.0 | 0.0 |
| of optical | T350-390(50)AVE (%) | 0.8 | 0.1 | 0.1 | 0.0 | 0.0 |
| filter | T350-390(50)MAX (%) | 4.7 | 0.6 | 0.7 | 0.3 | 0.0 |
| | T400-430(0)AVE (%) | 44.9 | 38.6 | 38.7 | 38.6 | 37.5 |
| | T430-500(0)AVE (%) | 94.1 | 93.5 | 93.5 | 93.4 | 92.9 |
| | UV50(0) (nm) | 414.7 | 417.0 | 417.0 | 417.0 | 417.4 |
| | \|UV10(0) − UV70(0)\| (nm) | 12.5 | 12.0 | 11.7 | 12.0 | 11.9 |
| | \|UV10(30) − UV70(30)\| (nm) | 21.5 | 13.3 | 13.5 | 13.4 | 13.1 |
| | \|ΔUV70-10(0) − UV70-10(30)\| (nm) | 9.0 | 1.3 | 1.8 | 1.3 | 1.2 |
| | IR50(0) (nm) | 643.2 | 643.0 | 642.9 | 643.0 | 642.8 |
| | IR50(30) (nm) | 640.0 | 639.9 | 639.9 | 639.9 | 639.9 |
| | IR50(0) − IR50(30)\| (nm) | 3.2 | 3.1 | 3.1 | 3.1 | 2.9 |

From the above results, the optical filters in Examples 3-1 to 3-3 and Examples 3-18 to 3-20 had a high transparency for the visible light and a high shielding property for the near-infrared light and the ultraviolet light, and in particular, the shielding property for the ultraviolet light did not decrease even at a high incident angle of 50 degrees, and good spectral characteristics were exhibited. Among them, even if an amount of adding the pigment was the same as in Examples 3-1 to 3-3 using one type of UV pigment, the optical filters in Examples 3-18 to 3-20 using two types of UV pigments having different maximum absorption wavelength regions could shield the near-ultraviolet light region more broadly and deeply than Examples 3-1 to 3-3.

In the optical filters of Examples 3-5 to 3-8 and 3-10 to 3-13, by using any one of the resin films 2-7 to 2-14 having the shielding property in the near-ultraviolet light region of 360 nm to 400 nm and the low transparency in the blue light region of 400 nm to 430 nm, at least one of the shielding property in the near-ultraviolet light region and the transparency in the visible light region at a high incident angle was low.

The optical filter in Example 3-9 had a large difference in steepness between the incident angles of 0 degrees and 30 degrees. This is because the optical filter 3-9 had an excellent steepness since the steepness of the optical filter 3-9 was highly dependent on steepness of the dielectric multilayer film at an incident angle of 0 degrees, whereas the steepness of the optical filter had decreased due to an increased influence of the UV pigment compound 10 which lacked the steepness at an incident angle of 30 degrees.

In the optical filters of Examples 3-4 and Examples 3-14 to 3-17, by using any one of the resin films in Examples 2-6 and Examples 2-15 to 2-18 in which the shielding property in the near-ultraviolet light region of 360 nm to 400 nm was low, the shielding property in the near-ultraviolet light region at a high incident angle was low.

In the optical filter of Example 3-21, since the film thickness of the resin film exceeds 3 m, it is considered that a resin film having a uniform film thickness cannot be obtained from a result of film thickness distribution evaluation to be described later.

### Evaluation of Light Resistance

### Example 4-1

A dielectric multilayer film (reflection film) in which 42 layers of SiO₂ and TiO₂ were alternately laid on or above one major surface of a glass substrate (alkali glass, D263 manufactured by schott) was formed by vacuum evaporation. A resin film was prepared on the other surface of the glass substrate in the same manner as in Example 2-1 using pigment compounds in contents shown in the following table. Thereafter, a dielectric multilayer film (antireflection film) in which SiO₂ and TiO₂ were alternately laid was formed on the resin film, and an optical filter was prepared.

### Examples 4-2 to 4-6

Optical filters were prepared in the same manner as in Example 4-1, except that a type and a content of the pigment compound were changed to values shown in the following table.

Each of the obtained optical filters was subjected to a weathering test using a super xenon weather meter manufactured by Suga Testing Machine Co. A residual ratio of the TR pigment was calculated from an absorption coefficient at 700 nm before and after the weathering test.

Incidence surface: irradiated from an antireflection film coating side

Light intensity: irradiated in a wavelength band of 300 nm to 2,450 nm such that an integrated light intensity was 80,000 J/mm².

Results are shown in the following table.

Examples 4-1 to 4-6 are reference examples.

TABLE 7

| | Example | Example | Example | Example | Example | Example |
|---|---|---|---|---|---|---|
| | 4-1 | 4-2 | 4-3 | 4-4 | 4-5 | 4-6 |
| UV pigment compound | 1 | 2 | 3 | 4 | 5 | — |
| Content of UV pigment (mass %) | 3.6 | 3.6 | 3.6 | 3.6 | 3.6 | — |
| IR pigment compound | 19 | 19 | 19 | 19 | 19 | 19 |
| Content of IR pigment (mass %) | 7.4 | 7.4 | 7.4 | 7.4 | 7.4 | 7.4 |
| IR pigment residual ratio | 88% | 86% | 90% | 76% | 37% | 85% |

In order to maintain performance of the optical filter, it is considered that the IR pigment residual ratio of 60% or more is necessary, and the IR pigment residual ratio of 60% or more could be achieved in all of the optical filters in Examples 4-1 to 4-4 in which any one of the UV pigment compounds 1 to 4 was allowed to coexist. It was found that the same level of pigment residual ratio was obtained compared to Example 4-6 in which no UV pigment coexisted, and thus the UV pigment compounds 1 to 4 did not promote deterioration of the TR pigment.

On the other hand, in the optical filter of Example 4-5 in which the UV pigment compound 5 coexisted, IR pigment deterioration was accelerated and the IR pigment residual ratio was significantly reduced.

### Evaluation of Film Thickness Distribution

### Examples 1-5 to 5-4

A polyimide resin (C-3G30G manufactured by Mitsubishi Gas Chemical Company) was dissolved in an organic solvent (cyclohexanone:γ-butyrolactone=1:1 mass ratio) at a concentration of 8.5 mass %.

To the solution of the polyimide resin prepared above, the compound 1 was added in an amount of 5 parts by mass, the compound 8 was added in an amount of 5 parts by mass, and the compound 19 was added in an amount of 5 parts by mass based on 100 parts by mass of the resin, and a mixture was stirred for 2 hours while being heated to 50° C. The pigment-containing resin solution was spin-coated onto a glass substrate (alkali glass, D263 manufactured by schott) which is 70 mm long×60 mm wide×0.2 mm thick at a rotational speed of 3,000 rpm to obtain a resin film.

### Examples 5-2 to 5-4

Resin films were obtained in the same manner as in Example 5-1, except that the rotational speed was changed as shown in the following table.

For each of the resin-film-equipped glass substrates obtained as described above, the film thickness was measured at each of nine centers of nine equal parts in a plane. An average value of measurement results at nine positions was calculated, and when ratios ((measured value/average value)×100) to the average value was 95% to 105%, it was determined that the film thickness was uniform and a film thickness distribution was good.

Results are shown in the following table.

Examples 5-1 to 5-4 are reference examples.

TABLE 8

| | Measurement | | | | | | | | | | Average |
|---|---|---|---|---|---|---|---|---|---|---|---|
| | position | 1 | 2 | 3 | 4 | 5 | 6 | 7 | 8 | 9 | value |
| Example 5-1 | 3000 (rpm) | 0.9777 | 0.9607 | 0.9699 | 0.9616 | 0.9578 | 0.9775 | 0.9739 | 0.9652 | 0.9534 | 0.97 |
| | Ratio to average | 101% | 99% | 100% | 100% | 99% | 101% | 101% | 100% | 99% | — |
| | value | | | | | | | | | | |
| Example 5-2 | 2000 (rpm) | 1.4629 | 1.4486 | 1.4681 | 1.4467 | 1.4376 | 1.4668 | 1.445 | 1.4504 | 1.4361 | 1.45 |
| | Ratio to average | 101% | 100% | 101% | 100% | 99% | 101% | 100% | 100% | 99% | — |
| | value | | | | | | | | | | |
| Example 5-3 | 1500 (rpm) | 1.9398 | 1.9497 | 1.9364 | 1.9436 | 1.9313 | 1.9572 | 1.9867 | 1.9854 | 1.9856 | 1.96 |
| | Ratio to average | 99% | 100% | 99% | 99% | 99% | 100% | 102% | 101% | 101% | — |
| | value | | | | | | | | | | |
| Example 5-4 | 1000 (rpm) | 2.9218 | 3.8916 | 3.8282 | 2.9424 | 2.8963 | 2.9455 | 2.9429 | 2.9201 | 2.9271 | 3.14 |
| | Ratio to average | 93% | 124% | 122% | 94% | 92% | 94% | 94% | 93% | 93% | — |
| | value | | | | | | | | | | |

In Examples 5-1 to 5-3 in which a film thickness average value was 3 μm or less, all measured values were within 95% to 105% of the average value, and it was found that the film could be uniformly formed.

In Example 5-4 in which the film thickness average value exceeded 3 μm, all measured values exceeded 95% to 105% of the average value, and a film thickness distribution was large.

From the above results, it was found that a uniform resin film was obtained when the film thickness was 3 μm or less.

Although the present invention has been described in detail with reference to specific embodiments, it is apparent to those skilled in the art that various changes and modifications can be made without departing from the spirit and scope of the present invention. The present application is based on a Japanese patent application (No. 2021-135204) filed on Aug. 20, 2021, and the contents thereof are incorporated herein by reference.

### INDUSTRIAL APPLICABILITY

The optical filter according to the present invention has a shielding property of near-infrared light and, transparency of visible light, and a good ultraviolet light shielding property in which deterioration in shielding property of ultraviolet light at a high incident angle is prevented. The optical filter is useful for applications of information acquisition devices such as cameras and sensors for transport machines, for which a high performance has been achieved in recent years.

### REFERENCE SIGNS LIST

1A, 1B, 1C, and 1D: optical filter
10: substrate
11: support
12: resin film
30: dielectric multilayer film

What is claimed is:

1. An optical filter comprising:
a substrate; and
a dielectric multilayer film laid on or above at least one major surface of the substrate, wherein
the substrate comprises a resin film comprising a resin, a UV pigment 1 having a maximum absorption wavelength in 360 nm to 390 nm in the resin, and an IR pigment having a maximum absorption wavelength in 680 nm to 800 nm in the resin, and
the optical filter satisfies all of the following spectral characteristics (i-1) to (i-8):
(i-1) an average transmittance T_{360-400(0)AVE} in a spectral transmittance curve at a wavelength of 360 nm to 400 nm and an incident angle of 0 degrees is 0.5% or less,
(i-2) an average transmittance T_{350-390(50)AVE} in a spectral transmittance curve at a wavelength of 350 nm to 390 nm and an incident angle of 50 degrees is 0.5% or less,
(i-3) an average transmittance T_{400-430(0)AVE} in a spectral transmittance curve at a wavelength of 400 nm to 430 nm and an incident angle of 0 degrees is 35% or more,
(i-4) an average transmittance T_{430-500(0)AVE} in a spectral transmittance curve at a wavelength of 430 nm to 500 nm and an incident angle of 0 degrees is 88% or more,
(i-5) in a spectral transmittance curve at a wavelength of 350 nm to 450 nm and an incident angle of 0 degrees, a wavelength UV50₍₀₎ at which a transmittance is 50% is 400 nm to 430 nm,
(i-6) when an absolute value of a difference between a wavelength UV10₍₀₎ when a transmittance is 10% and a wavelength UV70₍₀₎ when the transmittance is 70% is ΔUV₇₀₋₁₀₍₀₎ in the spectral transmittance curve at the wavelength of 350 nm to 450 nm and the incident angle of 0 degrees, and an absolute value of a difference between a wavelength UV10₍₃₀₎ when a transmittance is 10% and a wavelength UV70₍₃₀₎ when the transmittance is 70% is ΔUV₇₀₋₁₀₍₃₀₎ in a spectral transmittance curve at a wavelength of 350 nm to 450 nm and an incident angle of 30 degrees,
an absolute value of a difference between ΔUV₇₀₋₁₀₍₀₎ and ΔUV₇₀₋₁₀₍₃₀₎ is 2.5 nm or less,
(i-7) in a spectral transmittance curve at a wavelength of 600 nm to 700 nm and an incident angle of 0 degrees, a wavelength IR50₍₀₎ at which a transmittance is 50% is 610 nm to 670 nm, and in a spectral transmittance curve at a wavelength of 600 nm to 700 nm and an incident angle of 30 degrees, a wavelength IR50₍₃₀₎ at which a transmittance is 50% is 610 nm to 670 nm, and
(i-8) an absolute value of a difference between the wavelength IR50₍₀₎ and the wavelength IR50₍₃₀₎ is 5 nm or less.

2. The optical filter according to claim 1, further satisfying the following spectral characteristic (i-9):
(i-9) the absolute value of the difference between the wavelength UV10₍₀₎ and the wavelength UV70₍₀₎ is 13 nm or less.

3. The optical filter according to claim 1, wherein a product of a content of the UV pigment 1 in the resin film and a thickness of the resin film is 15 (mass %·μm) or less.

4. The optical filter according to claim 1, wherein the resin film further comprises a UV pigment 2 having a maximum absorption wavelength in 390 nm to 405 nm in the resin, the maximum absorption wavelength being larger than that of the UV pigment 1 by 10 nm or more, and
a product of a total content of the UV pigment 1 and the UV pigment 2 in the resin film and a thickness of the resin film is 15 (mass %·μm) or less.

5. The optical filter according to claim 1, wherein the UV pigment 1 satisfies all of the following spectral characteristics (ii-1) to (ii-3) in a spectral internal transmittance curve of a coating film obtained by dissolving the UV pigment 1 in the resin and coating an alkali glass plate with a mixture,
(ii-1) an absorbance at a maximum absorption wavelength is 0.1 (/mass %·μm) or more,
(ii-2) in the spectral internal transmittance curve of the coating film in which an internal transmittance at a maximum absorption wavelength is 1%, an average internal transmittance T_{350-400AVE} at a wavelength of 350 nm to 400 nm is 13% or less, and
(ii-3) in the spectral internal transmittance curve of the coating film normalized such that the internal transmittance at the maximum absorption wavelength is 1%, an absolute value of a difference between a wavelength UV10 when an internal transmittance at a wavelength of 350 nm to 450 nm is 10% and a wavelength UV70 when an internal transmittance is 70% is 10 nm or less.

6. The optical filter according to claim 1, wherein the UV pigment 1 is a cyanine compound represented by the following formula (S): 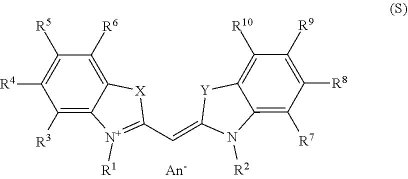
[Symbols in the above formula are as follows.
R¹ and R² each independently represent an alkyl group having 1 to 4 carbon atoms;
R³ to R¹⁰ each independently represent a hydrogen atom, a halogen atom, a sulfo group, a hydroxyl group, a cyano group, a nitro group, a carboxy group, a phenyl group, an alkyl group having 1 to 10 carbon atoms which may have a substituent, an alkoxy group having 1 to 10 carbon atoms which may have a substituent, an acyloxy group having 1 to 10 carbon atoms which may have a substituent, —NR¹¹R¹² (R¹¹ and R¹² are each independently a hydrogen atom, an alkyl group having 1 to 10 carbon atoms which may have a substituent, —C(═O)—R¹³ (R¹³ is an alkyl group having 1 to 10 carbon atoms or an aryl group having 6 to 11 carbon atoms, which may have a substituent), —SO₂—R¹⁴ (R¹⁴ is an alkyl group having 1 to 10 carbon atoms or an aryl group having 6 to 11 carbon atoms, which may have a substituent)), or —SO₂—R¹⁵ (R¹⁵ is an alkyl group having 1 to 10 carbon atoms or an aryl group having 6 to 11 carbon atoms, which may have a substituent, or —NR¹⁶R¹⁷ (R¹⁶ and R¹⁷ each independently represent a hydrogen atom or an alkyl group having 1 to 10 carbon atoms which may have a substituent));
X and Y each independently represent 0, S, or —C(CH₃)₂; and
An⁻ represents a monovalent anion.]

7. The optical filter according to claim 6, wherein X and Y are O in the cyanine compound represented by the formula (S).

8. The optical filter according to claim 1, wherein the resin film satisfies all of the following spectral characteristics (iii-1) to (iii-9):
(iii-1) an internal transmittance T₃₆₀ at a wavelength of 360 nm is 25% or less,
(iii-2) an internal transmittance T₃₇₀ at a wavelength of 370 nm is 10% or less,
(iii-3) an internal transmittance T₃₈₀ at a wavelength of 380 nm is 4% or less,
(iii-4) an average internal transmittance T_{360-400AVE} in a spectral transmittance curve at a wavelength of 360 nm to 400 nm is 15% or less,
(iii-5) an average internal transmittance T_{400-430AVE} in a spectral transmittance curve at a wavelength of 400 nm to 430 nm is 40% or more,
(iii-6) an average internal transmittance T_{430-500AVE} in a spectral transmittance curve at a wavelength of 430 nm to 500 nm is 90% or more,
(iii-7) in a spectral transmittance curve at a wavelength of 350 nm to 450 nm, an absolute value of a difference between a wavelength UV10 when an internal transmittance is 10% and a wavelength UV70 when an internal transmittance is 70% is 17 nm or less,
(iii-8) an internal transmittance T₇₀₀ at a wavelength of 700 nm is 5% or less, and
(iii-9) in a spectral transmittance curve at a wavelength of 600 nm to 700 nm, a wavelength IR50 at which an internal transmittance is 50% is 610 nm to 670 nm.

9. The optical filter according to claim 4, wherein the UV pigment 2 comprises a merocyanine compound.

10. The optical filter according to claim 1, wherein the IR pigment comprises at least one compound selected from the group consisting of a squarylium compound, a phthalocyanine compound, and a cyanine compound.

11. The optical filter according to claim 1, wherein the resin is a transparent resin.

12. The optical filter according to claim 11, further comprising a polyimide resin as the transparent resin.

13. An imaging device comprising the optical filter according to claim 1.
